(19) United States
(12) Patent Application Publication
(10) Pub. No.: US 2025/0245751 A1
(43) Pub. Date: Jul. 31, 2025

(54) System and Methods for Blockchain-Based Distributed Risk Transfer for Providing Financial Coverage

(71) Applicants: James Patrick Flannery, Lansdowne, PA (US); William Klein, Warwick, NY (US)

(72) Inventors: James Patrick Flannery, Lansdowne, PA (US); William Klein, Warwick, NY (US)

(21) Appl. No.: 19/034,912

(22) Filed: Jan. 23, 2025

Related U.S. Application Data
(60) Provisional application No. 63/626,935, filed on Jan. 30, 2024.

(51) Int. Cl. G06Q 40/08; G06Q 20/36; G06Q 20/38

(52) U.S. Cl. CPC G06Q 40/08; G06Q 20/3678; G06Q 20/389; G06Q 2220/10

(57) ABSTRACT

Systems, apparatuses, and methods disclosed for providing a marketplace platform that allows users to enter into risk transfer smart contracts to secure and provide financial coverage against the possible damage and losses that may occur from environmental conditions or events. Embodiments function to help close the large coverage gap that exists in the market for asset owners and to allow those asset owners with either hard-to-insure assets or with hard-to-insure client profiles an option for coverage against the effects of environmental conditions or events that are parametrically measured. An exemplary embodiment of this disclosure is focused on elevated space weather conditions.

### CROSS REFERENCE TO RELATED APPLICATION

This application claims the benefit of U.S. Provisional Application No. 63/626,935, filed Jan. 30, 2024, entitled “System and Methods for Blockchain-Based Distributed Risk Transfer for Providing Financial Coverage”, the disclosure of which is incorporated, in its entirety (including the Appendix) by this reference.

### BACKGROUND

Insurance is often used as a form of protection against asset loss or harm to the operation of a business. The number or type of available insurance products may depend on the assets involved, the parties involved (i.e., the operator of a business or participant in an activity), the location of the asset it is desired to insure, the specific risks involved for that asset, the competition in the market to provide an insurance product, or the expected cost of covering a loss, as well as other relevant factors.

While insurance products are typically available for many types of potential loss (home, auto, life, or business), there remain unserved or under-served categories of assets or businesses ventures. There also remain unserved or under-served parties representing categories of assets or business ventures exposed to elevated environmental conditions that seek to acquire coverage and are unable to using conventional methods. There also remain obstacles to coordinating the efforts of those parties that might be interested in providing an insurance type product and those parties desiring coverage.

One such category is that of Low Earth Orbit (LEO) satellites and other assets located in space. Another related category is that of assets located on Earth that may be adversely impacted by events originating in space, such as solar flares or coronal mass ejections (CME). This category includes electrical grids, communications systems, and certain types of devices prone to damage by geomagnetic disturbance (GMD).

What is desired are systems, apparatuses, and methods for addressing the need for effective risk transfer products for assets vulnerable to elevated environmental conditions or events, such as assets located in space and/or assets on the Earth that may be adversely impacted by events originating in space. In this regard, there exists a need in the insurance market for a risk transfer solution to address the shortcomings of conventional insurance approaches and to close the coverage gap that exists for the commercial and private space industry. Embodiments of the disclosure described herein address this and other objectives both individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the systems, apparatuses, and methods disclosed herein are directed to systems, methods, and apparatuses for providing a marketplace platform that allows users to enter into risk transfer smart contracts to provide financial coverage against the possible damage and losses that may occur from environmental conditions such as precipitation, flooding, earthquake, and other atmospheric weather. Embodiments function to help close the large coverage gap that exists in the market for asset owners and to allow those asset owners with either hard-to-insure assets or with hard-to-insure client profiles an option for coverage against the damaging effects of elevated environmental conditions.

While applications of the disclosed systems, apparatuses, and methods are applicable to providing a marketplace platform for risk transfer contracts directed to protecting assets from atmospheric weather, conditions and its effects, and environmental events such as earthquakes, in one embodiment, the disclosure is directed to providing a marketplace that enables users to enter into risk transfer smart contracts to provide financial coverage against the possible damage and losses that may occur from elevated space weather conditions. In this regard, embodiments function to help close the large coverage gap that exists in the market for asset owners and to allow those asset owners with either hard-to-insure assets or with hard-to-insure client profiles an option for coverage against the damaging effects of elevated space weather conditions.

The Sun is an ordinary star (G-type main sequence), and one of about 100 billion in our galaxy, the Milky Way. However, while somewhat ordinary as stars go, the Sun has extremely important influences on the Earth; its emissions and events drive Earth's weather, ocean currents, seasons, and climate, and makes plant life possible through photosynthesis. It is also the source of space “weather”, which is a term used to describe conditions in the region of space close to the Earth. This includes the presence of electromagnetic radiation and charged particles emitted by the sun that can affect human activity and interfere with the operation of electronic technology in space and on the Earth.

The origin of space weather can be traced to the ongoing contortions in the Sun's magnetic field, leading to cooler areas or sunspots on its surface. It is from these spots that space weather-causing phenomena such as solar flares (sudden bursts of radiation) and coronal mass ejections (CME, sudden bursts of plasma and magnetic field structures from the sun's atmosphere), can emerge.

Scientists analyze sunspot regions daily to assess the threats to earthbound systems and devices. They monitor and record changes in sunspot size, number, and position to evaluate the likelihood of an Earth-directed solar flare and/or CME (coronal mass ejection) from an active region. Sunspot activity rises and falls on a roughly 11-year cycle, known as the solar cycle. The beginning of the solar cycle is called the solar minimum, or when the Sun has the least sunspots. Over time, solar activity—and the number of sunspots—increases. The middle of the solar cycle is the solar maximum, or when the Sun has the most sunspots. As the cycle ends, it fades back to the solar minimum and then a new cycle begins.

Space weather can produce electromagnetic fields that induce extreme currents in wires, disrupting power lines, and may even cause widespread power outages. Severe space weather also produces energetic particles, which can damage electronics and satellites used for commercial communications, global positioning, intelligence gathering, and earth weather forecasting. For example, solar storms create risk for industries that are susceptible to solar storm induced geomagnetic disturbances. These industries include airlines, railways, pipelines, electrical grids, satellites, space tourism, any industry reliant on GPS, and any industry or business reliant on the services these industries provide. The potential impacts of solar storms are radiation exposure for astronauts and humans flying at aviation altitudes, service interruptions, and electronic equipment asset damage. Satellites and high-voltage electrical transformers are especially vulnerable to damage from extreme solar storms that can prematurely age and permanently destroy orbiting and ground-based equipment.

In one embodiment, the disclosure is directed to a computer-implemented method for providing a form of risk transfer (without being conventional insurance) for an underserved category of risk or entity exposed to such risk.

The solution disclosed herein is a contractual risk transfer and not a form of insurance (which is a subcategory of risk transfer). This is beneficial as insurance products often are accompanied by compliance issues because insurance is a tightly regulated industry. In contrast to that type of product, the disclosed approach utilizes a marketplace platform that while facilitating the entering of risk transfer smart contracts, doesn't undertake any risk transfer liability itself under a contract of insurance with the parties to compensate or indemnify a person in the event of loss or damage. Rather, the disclosed approach provides a free market based system that functions to directly connect entities that are seeking to hedge against risk and entities seeking to provide liquidity for those hedges.

In one embodiment, the category of risk is that arising from events in space (referred to herein as space weather) that can negatively impact space borne systems and/or earth-bound systems and services. In one embodiment, the events may include coronal mass ejections (CME), magnetic field variations, solar flares, or radiation of high-energy particles. In one embodiment, the method may include one or more of the following steps, stages, operations, or functions:
(1) establishing a connection between a platform, apparatus, or server and a plurality of cryptocurrency wallets, with each wallet associated with one of a plurality of user computer devices-note that this may occur after an interested user connects to and establishes an account with the marketplace RTSC computing device (typically a server that forms part of a platform or system);
(2) storing a plurality of account profiles, with one such profile associated with each computing device of the plurality of user computing devices, wherein each profile includes a unique user identifier, and the amount of cryptocurrency balances verified by each respective cryptocurrency wallet;
(3) receiving at the platform, apparatus, or risk transfer smart contract server (referred to as a RTSC device herein), via one or more associated network interfaces, from at least one user computer device of the plurality of the user computer devices, a proposed smart contract order to hedge against specific space weather conditions (“hedge order”), wherein the hedge order includes a hedge cost (referred to herein as a hedge premium), the risk coverage amount sought, payout conditions, the specified data sources, and in some cases, other available smart contract user parameters or options;
   Such other parameters or options may include, but are not limited to: a discount or price adjustment variable to override a default automatic hedge premium calculation which may be based on risk coverage sought and known probabilities of index levels being reached, RTSC fee sharing percentages, number of blockchain Oracle checks over contract duration, conditionality of index levels reached to disburse hedge premium payment to risk party, two or more thresholds for a single index level with discrete hedge premiums, or risk coverage amounts;
(4) receiving at the RTSC device, via one or more associated network interfaces, from at least one user computing device of the plurality of the user computer devices, a proposed smart contract order to cover the risk coverage amount sought (“risk order”), wherein the risk order includes a hedge premium, the risk coverage amount offered, payout conditions, the specified data sources, and in some cases other available smart contract user parameter or option (such as those mentioned previously);
(5) generating, in response to receiving matching (or otherwise sufficiently compatible) orders for both the hedge order and the risk order, a smart contract in a blockchain structure, wherein the smart contract includes at least one hedge user identifier, at least one risk user identifier, the hedge premium, the risk coverage amount, the payout conditions, the specified data sources, and if relevant other available smart contract user parameter(s) or option(s) selected by the hedge user and/or risk user;
   In this context, “matching” refers to associating a hedge order with a compatible risk order, typically through an identical match between parameters and options, although other approaches (such as a “match” within a prescribed range of values) may also be used;
(6) In some embodiments, the method may include additional, less, or alternate actions, including those disclosed and/or described elsewhere herein;
   Non-limiting examples include rewards, fees, selection of indexes, index ranges, or two outcomes covered in one RTSC.

In one embodiment, the disclosure is directed to a system for providing a form of risk transfer for an underserved category of risk or entity exposed to such risk. In one embodiment, the category of risk is that arising from events in space (referred to herein as space weather) that can negatively impact space borne systems and/or earth-bound systems and services. In one embodiment, the events may include CMEs, magnetic field variations, solar flares, or radiation of high-energy particles. The system may include a set of computer-executable instructions stored in (or on) a memory or data storage element (such as a non-transitory computer-readable medium) and one or more electronic processors or co-processors. When executed by the processors or co-processors, the instructions cause the processors or co-processors (or a device of which they are part) to perform a set of operations that implement an embodiment of the disclosed method or methods.

In one embodiment, the disclosure is directed to a non-transitory computer readable medium containing a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed and/or described herein may provide services through a SaaS or multi-tenant platform. In such an embodiment, the Saas platform may operate or function as an element of the disclosed marketplace. The platform provides access to multiple entities, each with a separate account and associated data storage. Each account may correspond to a hedge user, a risk user, or other entity utilizing the platform, a set or category of entities, a set or category of users, a set or category risks caused by space-related weather events, a set or category of objects or services impacted by space weather events, an industry, or an organization, as non-limiting examples. Each account may access one or more services, a set of which are instantiated in their account, and which implement one or more of the methods or functions disclosed and/or described herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 depicts a risk transfer smart contract (RTSC) system and method for generating smart contracts and implemented with a RTSC computing device;

FIG. 2 depicts a RTSC system and method for utilizing a blockchain Oracle to determine if a payout condition has occurred and distribute tokens to the correct counterparties;

FIG. 3 depicts an example smart contract for a space weather risk transfer system and method;

FIG. 4 depicts a marketplace platform system and method wherein the marketplace platform may connect, via one or more network interfaces on the RTSC computing device;

FIG. 5 depicts a Customer Due Diligence (CDD) and user eligibility verification system and method;

FIG. 6 depicts a non-custodial marketplace for risk transfer smart contracts wherein the marketplace platform may receive a connection request from the hedge party to connect their hedge party wallet via a graphical user interface;

FIG. 7 depicts an automated order entry system and method;

FIG. 8 depicts a cryptocurrency gas estimation module (GEM) system and method;

FIG. 9 depicts market order splitting (MOS) system and method;

FIG. 10 depicts a system and method to incentivize participation in providing risk coverage;

FIG. 11 depicts a system and method for the marketplace platform;

FIG. 12 depicts a system and method for conventional insurance carriers to participate in space weather risk transfer;

FIG. 13 is a diagram illustrating elements or components that may be present in a computer device or system configured to implement a method, process, function, or operation in accordance with an embodiment of the system and methods disclosed herein; and

FIGS. 14-16 are diagrams illustrating an architecture for a multi-tenant or SaaS platform that may be used in implementing an embodiment of the systems and methods disclosed herein.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among others, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, co-processor, CPU, GPU, TPU, QPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored in (or on) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a Saas platform or a service provided through such a platform.

In some embodiments, the systems and methods disclosed and/or described herein may provide services through a SaaS or multi-tenant platform. In such an embodiment, the Saas platform may operate or function as an element of the disclosed marketplace. The platform provides access to multiple entities, each with a separate account and associated data storage. Each account may correspond to a hedge user, a risk user, or other entity utilizing the platform, a set or category of entities, a set or category of users, a set or category risks caused by space-related weather events, a set or category of objects or services impacted by space weather events, an industry, or an organization, as non-limiting examples. Each account may access one or more services, a set of which are instantiated in their account, and which implement one or more of the methods or functions disclosed and/or described herein.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

In the context of the disclosure, the following terms and acronyms have at least the indicated definitions and/or meanings:
AML—Anti-Money Laundering
APY—Annualized Percentage Yield
CDD—Customer Due Diligence
CME—Coronal Mass Ejection—an outflow of plasma from or through the solar corona. Earth impacting CMEs can result in significant geomagnetic storms.
Dst—Disturbance Storm Time—a measure of variation in the geomagnetic field due to the equatorial ring current. It is computed from the H-components at approximately four near-equatorial stations at hourly intervals. At a given time, the Dst index is the average of variation over all longitudes. The reference level is set so that Dst is statistically zero on internationally designated quiet days. An index of −50 nT or deeper indicates a storm-level disturbance, and an index of −200 nT or deeper is associated with middle latitude aurorae. Dst is determined by the World Data Center C2 for Geomagnetism, Kyoto University, Kyoto, Japan.
F10.7—The solar radio flux at 10.7 cm (2700 MHz) otherwise known as the F10.7 index
FDIC—Federal Deposit Insurance Corporation
FEMA—Federal Emergency Management Agency
Flare—A sudden eruption of energy in the solar atmosphere lasting minutes to hours, from which radiation and particles are emitted.
GEM—Gas Estimation Module for smart contract transaction fees.
GEO—Among satellite operators, a common abbreviation for Geostationary Earth Orbit
Geomagnetic Field—The magnetic field in and around the Earth.
Geomagnetic Storm—(1) A worldwide disturbance of the Earth's magnetic field, distinct from regular diurnal variations. A storm is precisely defined as occurring when the daily Ap index exceeds 29, or (2) NOAA Space Weather Scale (G) for geomagnetic storm disturbances.
GPS—Global Positioning System is a network of Earth-orbiting satellites used for precise position-finding in surveying and navigation.
GUI—Graphical User Interface
HF—High Frequency.
IMF—Interplanetary Magnetic Field is the magnetic field carried with the solar wind.
Kp—Planetary K-Index—a common index used to indicate the severity of the global magnetic disturbances in near-Earth space. Kp is an index based on the average of weighted K indices at 13 ground magnetic field observatories. It is based on the range of the magnetic field variation within 3-hour intervals that is caused by phenomena other than the diurnal variation and the long-term components of the storm time variations. The values of the Kp range from 0 (very quiet) to 9 (very disturbed) in 28 discrete steps.
KYC—Know Your Customer.
LEO—Among satellite operators, a common abbreviation for Low Earth Orbit.
Magnetosphere—The magnetic cavity surrounding a magnetized body, carved out of the passing solar wind by virtue of the magnetic field, which prevents, or at least impedes, the direct entry of the solar wind plasma into the cavity.
MEO—Among satellite operators, a common abbreviation for Medium Earth Orbit.
MOS—Market Order Splitting is a system and method of splitting sizeable orders into smaller orders that may be matched for smart contract generation.
NOAA—The National Oceanic and Atmospheric Administration.
nT—Nanoteslas, a unit of magnetic flux density equal to 10-9 tesla.
RTSC—Risk Transfer Smart Contract(s).
SWPC—Space Weather Prediction Center is a division of NOAA responsible for providing predictions and data of space weather conditions.
UV—Ultraviolet.

Currently available insurance products for objects in space or for protection against space-related events that may cause harm to systems or objects on the surface of the Earth has limited risk capacity and does not presently meet the needs of clients with a growing asset base vulnerable to elevated space weather conditions. The “space insurance” market does not cover many assets that are considered hard-to-insure, including for example, low earth orbit (LEO) satellites which make up the majority of satellites in earth's orbit, due in part to the difficulty in modeling collision risk in this increasingly populated region of space.

Conventional space insurance providers are exiting the market due to losses in recent years as claims payments made to clients exceeded premiums received. With the remaining conventionally available space insurance policies, clients are often faced with expensive insurance premiums, and limited coverage amounts as dictated by the insurance carrier underwriting team and in the event these clients initiate a loss claim for coverage, they are not guaranteed rapid settlement and must provide proof of loss during an oftentimes complicated and contentious claims process.

Parametric insurance is a non-traditional insurance product that offers pre-specified payouts based upon a triggering event or situation. Trigger events depend on the nature of the parametric policy and can include environmental triggers such as wind speed and rainfall measurements, or business-related triggers such as foot traffic or system's load. Parametric or index-based insurance while hypothetically providing the speed and reliability of settlement payments that is desired is still insurance offered and underwritten by centralized entities and is subject to the eligibility limitations of hard-to-insure assets and hard-to-insure clients that may prohibit coverage altogether. Further, at present, parametric or index-based space insurance does not exist. Because of these and other reasons, a large and growing coverage gap has developed and is expected to continue growing as more assets become vulnerable to events originating in space. Even if parametric space insurance was made available from a conventional insurance carrier, the coverage eligibility and policy costs would still be subject to asset or user bias screening, and if coverage is provided, any coverage limitations dictated by the insurance provider's underwriting rules would leave clients underserved and vulnerable to financial losses due to the coverage gap.

There exists a need in the insurance and re-insurance markets for a risk transfer solution to address the present shortcomings of available approaches to providing space insurance, and to close the large coverage gap that exists in the commercial and private space industry. This includes providing protection for risks to satellites, ground station electronics, space travel vehicles, orbiting stations, and experimental apparatus, as non-limiting examples.

In some embodiments, a marketplace platform is provided that allows users to enter into risk transfer enabling “smart contracts” to provide financial coverage against the possible damage and losses that may occur from elevated space weather conditions. Such a platform and associated services are needed to help close the coverage gap that exists in the market for asset owners. This will allow those asset owners with either hard to insure assets or with hard to insure client profiles an option for coverage against the damaging effects of elevated space weather conditions.

Embodiments of the disclosure also provide a method or service for assuring sufficient risk capacity, unbiased with regards to asset and client identity or risk profile. Embodiments provide automatic and parametric payout settlements to asset owners vulnerable to the effects of elevated space weather conditions through the transfer of space weather risk.

Risk Transfer is a term used in the insurance industry to define the concept of risk management, which means the transfer of risk (i.e., future risk) from a party (individual or corporate) to another party such that in case a specific event or harm occurs in the future, the insured party receives some form of compensation or adjustment. This has the result of transferring the risk of a future event, which may or may not happen, to another party.

In one sense, risk transfer is a risk management and risk control strategy that involves the contractual shifting of a risk or some aspect of risk from one party to another. One example is the purchase of an insurance policy, through which a specified risk of loss is passed from the policyholder to the insurer. In the context of this disclosure, risk transfer is a risk management mechanism that functions to shift the responsibility for a potential unfavorable outcome from one party to another in return for agreeing to an arrangement typically involving payment of an amount determined by consideration of the risk type, the likelihood of an event occurring that causes the risk, and the expected loss if the event occurs.

Typically, a risk transfer is for a future event, and involves a contractual arrangement between two parties, wherein the first party pays a premium to a second party, in exchange for the second party's promise to pay a benefit to the first party in the event of a covered loss. The risk transfer acts to mitigate financial losses due to loss or damage to an asset for which such risk management and protection is arranged.

As mentioned, parametric insurance is a type of insurance wherein a triggering event or state results in a payout (termed a parametric payout) when a specific physical or natural parameter (such as the amount of rainfall in a defined region or place, or the wind speed of a hurricane in a defined place) exceeds a set threshold value. These parameters are typically measured by independent third parties and do not require complex and/or contentious loss-adjustment assessments or claims processing.

Parametric insurance payouts depend upon natural parameters that are measurable and validated by an agreed upon source, rather than a measure of physical or calculated financial damage. As a result, parametric insurance enables the transfer of specifically defined risks, with expectation of greater transparency and more rapid settlement than conventional non-parametric insurance approaches. Parametric insurance is therefore a form of insurance well-suited as a tool for transferring very specific risks in often under-insured asset classes or regions, with a high level of transparency and rapid settlement of claims following a trigger condition or event.

However, conventional forms of parametric insurance are still provided and underwritten by a centralized authority that has limited risk capacity, can deny coverage based on asset or client profile, and dictates the terms of the policy. These are all disadvantages to the conventional approach and are overcome by embodiments of the disclosed solution.

Uninsurable peril risk is a relatively widespread occurrence across the human experience. Uninsurable perils are events for which insurance coverage is not available or for which insurers are unlikely to underwrite policies. While an uninsurable peril is typically an event with a relatively high risk of occurrence, it may also include events that are catastrophic in nature, such as those for which the probability of a payout is considered high or expected, as well as including perils with a relatively low-frequency of occurrence but that are accompanied by a high-severity outcome or harm.

A classic example of an uninsurable peril or risk is a flood condition in a known flood area for a home builder or owner. Because the area has a history of that peril, it is unlikely an insurance company will want to extend flood coverage because of the difficulty in managing the potential risk. This difficulty arises at least in part, from insufficiently predictive catastrophe models that simulate a wide range of possible events and their impact on current or potential risk portfolios.

The difficulty in managing such risks is a primary reason why flood insurance exists as a government program managed by the Federal Emergency Management Agency (FEMA) instead of as a subset of private insurance. For example, emerging private markets for flood insurance are facing severe challenges because many of the catastrophe models are outdated as climate change impacts the accuracy and ability of the existing models to predict risk for what are now higher frequency, higher severity events than those that occurred previously. In this regard, insufficient or inaccurate modeling may discourage private insurers from entering the market, thereby leading to increasing coverage gaps.

Space weather data arising from solar activity is collected by an international consortium of observatories, averaged for particular environments, and published as space weather indices by several space weather agencies. The values of these indices help in interpreting and evaluating trends, and the overall conditions indicated by the collected data and may be used to describe the “state” of various space weather environments.

Space weather index value(s) also describe the strength of specific space weather events or conditions. Space weather conditions reflected by the indices may include, but are not limited to, Planetary K-Index (Kp), F10.7 index, and Disturbance Storm Time index (Dst). Elevated measurements within the expected range of these indices may indicate a relatively high probability of risk for damage or loss for geomagnetically vulnerable assets such as spacecraft, satellites, and Earth's ground-based power grids.

The Planetary K-Index (Kp) is used to characterize the magnitude of geomagnetic storms. Kp is an indicator of disturbances in the Earth's magnetic field and may be used to decide whether geomagnetic alerts and warnings should be issued to industries impacted by geomagnetic disturbances. The F10.7 cm index correlates well with the sunspot number. Dst (disturbance storm time) index is a measure of the decrease in the horizontal component of the Earth's magnetic field near the magnetic equator due to increases in the magnetospheric ring current. The Dst index may be used to analyze the strength and duration of geomagnetic storms, with Dst being measured in nanoteslas (nT) with a lower number indicating a stronger storm.

As mentioned, space weather events may create risk for industries, services, and devices that are susceptible to geomagnetic disturbances induced by elevated space weather conditions (such as charged particles, radiation, or magnetic field fluctuations, as non-limiting examples). These industries, services, and devices include but are not limited to airlines, railways, pipeline operators, electrical grid operators, satellites, space tourism services, and industries reliant on GPS, including transportation and shipping.

The potential impacts of space weather include but are not limited to radiation exposure for astronauts and humans flying at aviation altitudes, essential service interruptions, and critical damage to electronic equipment. Satellites and high-voltage electrical transformers are especially vulnerable to damage from elevated space weather conditions that can prematurely age and may permanently destroy orbiting and ground-based equipment. As is clear from these examples, damage from space-based events can be harmful to both commercial and government assets.

Space weather events can produce electromagnetic fields that induce extreme currents in wires, disrupting power lines, creating voltage control problems, and in some cases causing widespread power outages which can have a significant adverse economic and/or societal impact. Severe space weather events may produce energetic solar particles, which can damage satellites used for commercial communications, global positioning, intelligence gathering, and earth weather forecasting. Low Earth Orbit (LEO) satellites are particularly vulnerable to the effects of elevated space weather conditions. During elevated space weather conditions causing geomagnetic disturbances, the Earth's atmosphere can expand, causing increased atmospheric friction on orbiting assets in LEO which could result in orbital placement problems leading to collisions and loss.

The largest geomagnetic storm in the modern record occurred in 1859 when a CME (coronal mass ejection) struck the earth's magnetosphere and is known as the Carrington event. The storm occurred in a largely pre-electrical age, so the impact was limited to damage to telegraph systems across North America and Europe.

On Mar. 13, 1989, a large geomagnetic storm caused widespread effects on power systems including a blackout of the Hydro-Québec system. After the storm, the Canadian government invested $1.2 billion to protect the Hydro-Québec grid infrastructure by installing numerous blocking capacitors.

On Jul. 23, 2012, a solar storm that was likely as energetic as the one that caused 1859's Carrington event narrowly missed the earth by one week. The Carrington event is estimated to have a minimum Dst under −850 nT, the Quebec storm of 1989 registered a Dst of −640 nT, and the 2012 extreme storm that narrowly missed the Earth had an estimated Dst of −1200 nT. Researchers from Lloyd's of London and the Atmospheric and Environmental Research agency in the U.S. estimated in 2013 that a Carrington-class event in today's modern society would result in between $0.6 and $2.6 trillion in damages to the United States alone. Inflation adjusted for 2024, this would result in between $0.8 and $3.5 trillion in damages today.

Insurance carriers typically utilize agents that serve as a first screening mechanism in an insurer's enrollment process by selecting clientele with a normal or preferred risk profile. Insurance carriers may deny coverage to specific assets that are deemed hard to insure as well as deny coverage to clients that are deemed hard to insure based on a carrier's own asset and client risk assessment information and decision process. The same limitations and disadvantages apply to conventional approaches to parametric insurance products. However, embodiments of the disclosed approach to providing a parametric risk transfer solution do not, and therefore are advantageous for many types of risk, insurance seekers, and industries.

Using conventional approaches, hard-to-insure assets are often either prohibitively expensive to cover fully, leaving them only partially covered, or are left entirely uncovered, leaving a significant coverage gap for asset owners within their asset portfolio. In some cases, clients being denied coverage by insurance carriers can be left with their entire asset portfolio uncovered and exposed to the risk of a crippling loss. If such uncovered clients are exposed to severe space weather conditions that cause significant damage to their assets, their operations could be dealt an unrecoverable economic blow without capital to rebuild their operations. This may result in both bankruptcy for the asset owner and a loss of a valuable and needed service to those they assist.

Since at present, only conventional insurance products exist for a limited number of space assets, and no parametric or index-based risk transfer solutions are offered, a claims process and proof of loss is required. This can result in delay, disputes, and litigation prior to a client receiving a payment, and with no guarantee of a claims payment being made to the client. In the event a client with a conventional insurance policy experiences a significant loss, and their claims are not paid rapidly due to a delay, dispute, or litigation, the client's business operational losses experienced during the time they wait for a payment could far exceed the damage to the assets.

The conventional space insurance industry has experienced losses in recent years which have exceeded policy premiums. Swiss Re, the world's second largest reinsurance company, exited the space insurance market (citing “bad results of recent years and unsustainable premium rates”), thus leaving significant coverage gaps for the nascent space industry. As the number of satellites placed into orbit increases while the access to insurance coverage for such assets decreases, satellite operators are increasing left without a coverage solution.

At present, approximately 99% of all low earth orbit satellites (the fastest growing asset class in space) do not have any in-orbit insurance coverage due to that asset class being hard to insure in part due to the difficulty in modeling collision risk in this highly populated region of space. As insurance companies leave the market, and more assets are being put into space, the aggregate value of assets in space (specifically the hard-to-insure low earth orbit class of satellites) increases, causing the coverage gap for assets in space to widen even further.

At present no parametric or index-based risk transfer solution is available for assets vulnerable to elevated space weather conditions which can affect both assets in space and on the earth. At present, it is not possible to insure against space weather as an isolated peril. The space weather risk transfer solution disclosed and/or described herein addresses many of the issues causing the ever-growing coverage gap experienced by the space insurance market.

As disclosed and/or described herein, there exists a need for more effective risk transfer products for assets located in space and/or assets on the Earth that may be adversely impacted by events originating in space. In this regard, there exists a need in the insurance market for a risk transfer solution to address the shortcomings of conventional approaches and to close the coverage gap that exists within the commercial and private space industry.

Providing a marketplace platform that allows users to enter into risk transfer smart contracts to provide financial coverage against the possible damage and losses that may occur from elevated space weather conditions is desirable to help close the coverage gap that exists in the market for asset owners and to allow those asset owners with either hard to insure assets or with hard to insure client profiles an option for coverage against the damaging effects of elevated space weather conditions. In some embodiments, a method of assuring sufficient risk capacity, unbiased to asset type and client identify or risk profile and providing guaranteed automatic and parametric payout settlements to asset owners vulnerable to the effects of elevated space weather conditions through the transfer of space weather risk is disclosed and/or described.

In some embodiments, the disclosure is directed to blockchain-based smart contracts, and more particularly, to systems and methods for implementing a space weather risk transfer platform based at least in part upon smart contracts and multiple data sources. In this sense, embodiments may incorporate blockchain-based systems and methods for establishing and operating a marketplace for space weather risk transfer.

Embodiments may include providing a platform and associated ecosystem for an efficient blockchain-based space weather risk transfer solution using smart contracts. A blockchain structure may include smart contacts that automatically cause funds (e.g., cryptocurrency or other forms of tokens) to be transferred from one user to another upon the occurrence of specified payout conditions being met.

One or more specified data sources (e.g., government or non-government agencies, news entities, research facilities, and/or other publishing entities) may be used to determine whether a payout condition has been met. Data sources may include Decentralized Physical Infrastructure Networks (DePINs) which are decentralized networks that leverage blockchain and token incentives to build and maintain physical infrastructure. DePINs utilizing environmental sensors may be used to provide data on localized parameters to determine whether a payout condition has been met (e.g., local rainfall levels).

Users may hold cryptocurrency funds accessed via decentralized, privately held non-custodial cryptocurrency wallets to be used in marketplace smart contracts. These privately owned cryptocurrency wallets store the users' keys and offer the functionality of encrypting and/or signing information, allowing the users (for example) to pay for contract costs including but not limited to hedge premiums, risk coverage amounts, transaction fees and contract service fees involved in space weather risk transfer smart contracts.

Users may interact with an embodiment of the disclosed and/or described system via an interface to a “marketplace” that enables users to enter into space weather risk transfer smart contracts to purchase space weather risk coverage and/or to provide space weather risk coverage to other users. When a user seeking to hedge against elevated space weather conditions (referred to as the “hedge party”) enters into a risk transfer smart contract with another user (referred to as the “risk party”), funds may be transferred via the users' respective cryptocurrency addresses as facilitated through the connection of their wallets in the amounts specified by the agreement and the smart contract is written to the blockchain structure.

If the system determines, based at least in part upon one or more agreed upon data sources specified in the smart contract, that a specified payout condition has been met, then the funds committed by the risk party in the form of risk coverage may automatically be transferred to the hedge party within the blockchain structure as a parametric payout. If the system determines that the specified payout conditions have not been met within the timeframe specified by the smart contact, then the funds committed by the hedge party (the party with an asset at risk) in the form of a hedge premium may automatically be transferred to the risk party (the party providing the risk coverage) within the blockchain structure.

In another embodiment, the funds committed by the hedge party in the form of a hedge premium may be agreed by both parties to automatically be transferred to the risk party at the initiation of the smart contract as payment to the risk party in exchange for the risk party providing the risk coverage described in the smart contract.

In one embodiment, the disclosure is directed to a computer-implemented method for providing a form of risk transfer financial product for an underserved category of risk or entity exposed to such risk. In one embodiment, the category of risk is that arising from events in space (referred to herein as space weather) that can negatively impact space borne systems and/or earth-bound systems and services. In one embodiment, the events may include coronal mass ejections (CMEs), magnetic field variations, solar flares, or radiation of high-energy particles.

An embodiment of the disclosed and/or described method may be implemented in whole or in part using what is referred to herein as a risk transfer smart contract (RTSC) computing device (such as a platform or server) and which is typically used in cooperation with a hedge or risk party's local user computing device (such as desktop or laptop device). The RTSC and local device(s) include one or more electronic processors and a set of computer-executable instructions. The computer-executable instructions may be stored in (or on) a non-transitory computer readable medium. When executed, the instructions cause the one or more processors (or a server, device, or platform in which they are contained) to implement the following steps, stages, functions, operations, or processes, where some may be performed at least in part by the hedge or risk party device and others by the RTSC platform or server:
(1) enabling a connection to a plurality of cryptocurrency wallets, with each wallet associated with one of a plurality of user (i.e., hedge or risk party) computer devices-note that this may occur after an interested user connects to and establishes an account with the marketplace RTSC computing device (typically a server that forms part of a platform or system);
(2) storing a plurality of account profiles in the RTSC computing device, with one such profile associated with each user computing device of the plurality of user computing devices, wherein each profile includes a unique user identifier, and the amount of cryptocurrency balances verified by each connected cryptocurrency wallet;
(3) receiving at the RTSC device, via one or more network interfaces on the RTSC computing device, from at least one user computer device of the plurality of the user computer devices, a proposed smart contract order to hedge against specific space weather conditions (referred to as a “hedge order”), wherein the hedge order includes a hedge premium, the risk coverage amount sought, one or more payout conditions, one or more specified data sources, and if desired, other available smart contract user parameter or option;
   As non-limiting examples, such smart contract user selected parameter(s) or option(s) may include a discount or price adjustment variable to override a default automatic hedge premium calculation which may be based on risk coverage sought and known probabilities of index levels being reached, RTSC service fee sharing percentages, desired number of blockchain Oracle checks over the contract duration, conditionality of index levels reached to disburse hedge premium payment to risk party, two or more thresholds for a single index level with discrete hedge premiums, or risk coverage amounts;
      A discount or price adjustment variable could override default risk probability-based hedge premium and coverage amounts which could be adjusted by either party in their orders to attract the opposite party with more attractive contract terms and increase the likelihood the order is matched during periods when an open order may not be matched otherwise. RTSC service fee sharing percentages may be employed by either party in their order as a way of attracting the opposite party into a contract by electing to pay a portion or all of the opposing party's RTSC service fee, thereby making the contract more attractive to the opposing party;
(4) receiving at the RTSC device, via one or more network interfaces on the RTSC computing device, from at least one user computing device of the plurality of the user computer devices, a proposed smart contract order to cover the risk coverage amount sought by the hedge order (referred to as a “risk order”), wherein the risk order includes a hedge premium, the risk coverage amount offered, one or more payout conditions, one or more specified data sources, and if desired, other available smart contract user parameter or option. As described further, this may involve a form of “matching” or associating a specific hedge order seeking coverage with a specific risk order offering coverage that conforms to that requested by the hedge order. In other cases, a risk order may be submitted, and the platform may then identify a hedge order that could be compatible;
(5) generating, in response to receiving matching (or sufficiently closely matched) orders for both the hedge order and the risk order, a smart contract in the blockchain structure, the smart contract including at least one hedge party/user identifier, at least one risk party/user identifier, the hedge premium, the risk coverage amount, the payout conditions, the specified data sources, and any other available smart contract user parameter or option used. The method may include additional, less, or alternate actions, including those discussed elsewhere herein;
   In this context, “matching” refers to associating a hedge order with a compatible risk order, typically through an identical match between parameters and options, although other approaches (such as a “match” within a prescribed range of values or for a set of specific characteristics) may also be used;
   Non-limiting examples of such additional or different actions include but are not limited to rewards, fees, selection of indexes, index ranges, or two outcomes covered in one RTSC, and Market Order Splitting of a sizeable order into smaller orders that may be matched for smart contract generation (as this allows relatively large hedge positions to be covered without having to find a single large risk party providing 100% of the risk coverage sought in the larger order).

In another embodiment, the disclosure is directed to a device, apparatus, server, or platform including one or more electronic processors and a set of computer-executable instructions. The computer-executable instructions may be stored in (or on) a non-transitory computer readable medium. When executed, the instructions cause the one or more processors (or a server, device, or platform in which they are contained) to implement an embodiment of the disclosed method or methods.

In yet another embodiment, the disclosure is directed to one or more non-transitory computer-readable media including a set of computer-executable instructions, wherein when executed by one or more electronic processors, the instructions cause the one or more processors (or a server, device, or platform in which they are contained) to implement an embodiment of the disclosed method or methods.

Embodiments of the disclosure are directed to systems and methods for implementing space weather risk transfer using smart contracts and multiple indices and acceptable data sources. In this context, a smart contract may be a computer protocol configured to digitally facilitate, verify, and/or enforce negotiation and/or performance of a contract term or condition (e.g., a decentralized risk transfer contract), and may be implemented using a blockchain structure (e.g., Ethereum). The blockchain structure may include smart contracts that automatically cause funds (e.g., cryptocurrency) to be transferred from one user to another upon the occurrence of a specified payout condition that is triggered by a smart contract clause.

As mentioned, one or more specified data sources may be used to automatically determine whether a payout condition has occurred. For example, the payout condition may be that a certain Kp index level is reached in a specified month, and the specified data source may be the National Oceanic and Atmospheric Administration (NOAA). The system or platform may include a database where data from multiple sources is stored in a standardized format.

The systems and method disclosed and/or described may enable users to connect their cryptocurrency wallets to the platform to provide funds required to enter into smart contracts. Alternatively, orders may place required funds for hedge premiums, contract service fees, gas fees and or coverage provided into provisional order contracts written to the blockchain ledger which act as an escrow commitment of digital assets for future matched orders that then get executed onto the blockchain ledger as active risk transfer smart contracts. This embodiment eliminates the need for users to keep their wallets connected until the moment contracts are entered into. The cryptocurrency wallets may each be associated with a unique identifier. Users may have a profile associated with their unique identifier. The user profile may contain one or more of KYC (know your customer) verification, accreditation status, eligibility status to enter into smart contracts, and user selected parametric risk criteria for space weather risk transfer order creation.

In some embodiments, the systems and methods disclosed and/or described may facilitate a marketplace for space weather risk transfer. Users (i.e., hedge or risk parties) may interact with the system via a marketplace interface that enables users to enter into space weather risk transfer smart contracts to purchase space weather risk coverage or to provide space weather risk coverage to other users.

Users in industries sensitive to elevated space weather conditions may enter into risk transfer smart contracts to protect their assets and business against financial loss due to space weather damage and disruption. Users seeking to provide space weather risk coverage for low-probability space weather conditions may enter into risk transfer smart contracts to have an acceptable likelihood of receiving the hedge premium with the knowledge that there is a relatively low probability of paying out the risk coverage.

As mentioned, space weather peril is not directly coverable by existing insurance solutions and the indirect coverage available by space insurers is limited and does not meet the full needs of asset owners. In one sense, space weather is currently an uninsurable peril for which insurance coverage is not available or for which insurers are unlikely to underwrite policies directly making this solution highly desirable.

A non-limiting example of the elements and parameters in a typical smart contract used to participate in the disclosed and/or described marketplace includes the following:
Threshold level of space weather index agreed to by both parties;
   This may refer to one or more accepted indices that are measurable by a reliable and agreed upon entity or party;
Start and end times of the contract;
Calculated odds of the space weather index level being reached. In one embodiment, this is based on published scientific consensus on the probabilities of various index levels being reached during each solar cycle, for example average frequency of physical measures of space weather phenomenon as measured by space weather indices provided by NOAA. An example of scientific consensus is it is generally understood among the scientific community that a space weather event similar in strength to the 1859 Carrington event has a 1% probability of occurring each year;
The amount of the tokens paid by each party is calculated by the odds of the space weather conditions being met; for example, if a particular index level selected for a contract order has a 1% probability of occurring each year, the default hedge premium for this event over the period of a one-year contract would be 1% of the coverage amount sought;
Hedge premium provided by hedge party;
Coverage amount provided by risk party;
Risk party participation rewards are calculated; risk parties may be incentivized to participate in contracts by the ability of risk parties to earn token participation rewards over the period of the contract as offered by the marketplace. The risk party earns both hedge premiums and token rewards as income to attract participation and offset the risk associated with providing the coverage for the contract. Rewards help to attract risk parties on the marketplace in search of early project token acquisition and income opportunities;
Settlement Processing stages (as an example):
   Record of the space weather index levels that are actually reached during the contract period;
   Payment of the hedge premium is made to the risk party at the initiation of the contract;
   Payment of the risk party participation reward is made to the risk party at expiration of the contract;
   Automatic settlement of the coverage defined in the contract occurs at expiration of the contract.

A non-limiting example of a smart contract that may be used as part of the disclosed system or platform is presented in the following. As mentioned, the disclosed and/or described system and associated methods are directed to a parametric space weather risk transfer system based on the strength of space weather conditions as reported in space weather indices. In an example embodiment, a party with assets exposed to the possibility of financial loss resulting from elevated space weather conditions and a desire to hedge against potential financial loss (herein referred to as the “hedge party”) utilizes an online marketplace to create a hedge order for a space weather risk transfer parametric payout smart contract that automatically disburses funds to them based on the triggering of a payout condition or set of conditions they define and that a risk party agrees to.

In this example, the hedge party (after consideration of the variables to define in their order) constructs a smart contract by providing the following information:
(1) enters the amount of financial risk coverage they are seeking as priced in a digital currency;
(2) defines the payout trigger thresholds of Kp index with a value of 9 and Dst index with a value of −350 nT;
(3) selects a period of 3 months for the duration of the RTSC; and
(4) enters the premium they agree to payout (hereinafter known as the hedge premium) to a risk covering counter party in exchange for receiving the risk capacity sought in their hedge order, and also agree that if the payout trigger thresholds defined in the RTSC are not met during the smart contract period, then no parametric payout settlement will be disbursed to them by the other party.

The risk covering counter party (the “risk party”) utilizes the online marketplace to access the hedge order information from one or more hedge parties and accept a set of conditions by agreeing to provide the risk capacity (herein referred to as the risk coverage) as priced in a digital currency for a specific space weather risk transfer parametric payout smart contract. In doing so the risk party receives the contract's hedge premium and accepts that the risk coverage defined in the RTSC is returned to them (or not automatically transferred to the hedge party) if the payout trigger thresholds are not met during the smart contract period and agrees to relinquish the provided risk coverage to the hedge party if the payout trigger thresholds are met during the smart contract period.

At the time both parties agree to the conditions of a smart contract, the RTSC computer device (which may be implemented as a platform or marketplace server), creates the smart contract, and publishes it on the blockchain structure. The smart contract may utilize a blockchain Oracle to detect if the Kp Index and Dst Index trigger thresholds are met during the contract period and controls the disbursement of a payout to the appropriate beneficiary party while recording the disbursement to the distributed ledger on the blockchain (or other accessible data storage structure being used).

In one example, a blockchain Oracle interacts with online sources of information and enables that information to be accessed by a blockchain. The Oracle can collect information from servers, websites, or other data source on the Web. Since an Oracle is connected to the Internet, it can supply and transmit the desired information to smart contracts in real-time. As examples, an Oracle can provide information such as exchange rates, digital asset prices, or other real-time data. In one possible outcome, a blockchain Oracle reports to the RTSC at the expiration of the contract that both Kp Index and Dst Index trigger thresholds were not met and therefore the risk coverage defined in the smart contract is returned to the risk party (or not transferred to the hedge party).

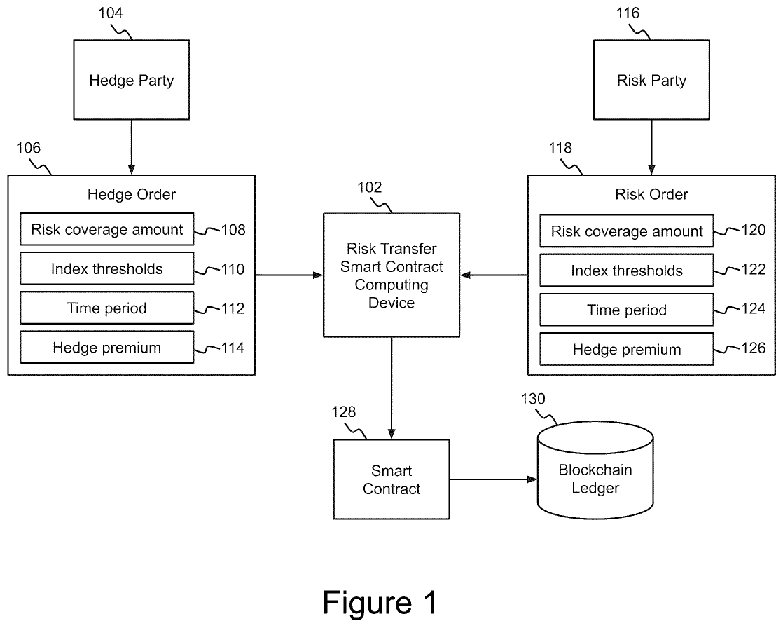

FIG. 1 depicts a risk transfer smart contract (RTSC) system and method 100 for generating smart contracts in accordance with an embodiment of the disclosure. The illustrated system may include a RTSC computing device 102 (e.g., a server or SaaS/multi-tenant platform), including at least one processor in communication with at least one memory device. In an example use case, a hedge party 104 may submit a hedge order 106 by setting one or more parameters of the hedge order 106, where the parameters may include but are not limited to:
the risk coverage amount sought 108;
the space weather index threshold(s) or values for the applicable index or indices 110 that will be used to determine if a payout condition is met;
the time period 112; and
the hedge premium offered 114.
   Similarly, a risk party 116 may submit a risk order 118 by setting one or more parameters of the risk order 110, where the parameters may include but are not limited to:
the risk coverage amount offered 120;
the space weather index threshold(s) or values for the applicable index or indices 122 that will be used to determine if a payout condition is met;
the time period 124; and
the hedge premium sought 126.

The RTSC computing device 102 (which may take the form of a server, platform, or apparatus) may identify a hedge order and a risk order with complimentary (i.e., compatible) parameters and then may “match” the two orders to generate a smart contract 128 with the parameters agreed upon by both parties as defined in the hedge and risk orders. The RTSC computing device may publish the generated smart contract to or in a blockchain structure 130 and may inform the hedge party 104 and risk party 116 that the smart contract 128 has been published on or in a blockchain ledger 130.

In some embodiments, the RTSC includes (or has access to) a value for a hedge premium and risk coverage as those are priced in a digital currency, space weather Index thresholds, and the duration of the smart contract. A blockchain Oracle containing regularly updated levels of off-chain space weather index data may be provided to serve as a method to determine if the space weather index thresholds in the contract have been met. The RTSC may poll the blockchain Oracle to determine if the space weather index thresholds were met and if so, thereby trigger the RTSC settlement and parametric payout condition in the contract, which automatically disburses the digital currency defined in the RTSC risk coverage to the hedge party. If at the RTSC expiration date, the RTSC determines from the blockchain Oracle data that the space weather index thresholds were not met, then the digital currency defined in the RTSC risk coverage may automatically be disbursed back to the risk party.

In one embodiment, at the conclusion of the smart contract time period, the RTSC may unconditionally disburse the digital currency defined in the hedge premium to the risk party regardless of the outcome of the risk coverage settlement. In another embodiment, the hedge premium digital currency may be disbursed back to the hedge party conditionally if the space weather index thresholds have been reached and the parametric payout is triggered. In another embodiment, the hedge premium digital currency may unconditionally be disbursed to the risk party at the initiation of the RTSC being entered onto the blockchain.

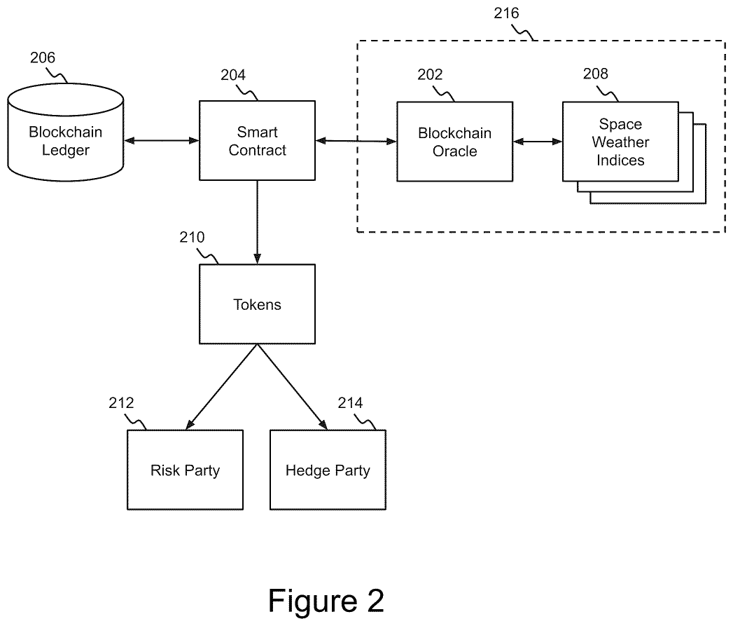

FIG. 2 depicts a Risk Transfer Smart Contract (RTSC) system and method 200 for utilizing a blockchain Oracle 202 to determine if the payout condition defined by the smart contract has occurred and disburse tokens representing digital currency to the correct party. In one embodiment, a smart contract 204 published to a blockchain ledger 206 may poll a blockchain Oracle 202 to determine if the payout condition has occurred. A blockchain Oracle 202 may access/receive data from a plurality of sources for a plurality of space weather indices 208 and may store space weather index data in a format accessible to a smart contract on a blockchain ledger. A blockchain oracle 202 together with the space weather indices 208 create a trusted method 216 for the settlement of the smart contract 204.

A blockchain Oracle 202 may make the retrieved and stored off-chain data available to the smart contract 204. In some embodiments, the tokens 210 are digital currency included in the smart contract 204 and consist of the hedge premium and the risk coverage amounts. The smart contract 204 may determine if the payout condition has occurred wherein the risk coverage in tokens 210 are transferred to the hedge party 214 if the payout condition has occurred. In some embodiments, the smart contract will transfer the hedge premium in tokens 210 to the risk party 212 at the end of the smart contract time period.

In some embodiments, the blockchain Oracle 202 continuously monitors for the occurrence of the space weather index thresholds defined by the RTSC and, upon detection of the occurrence of the thresholds being met, disburses a payout. The blockchain Oracle 202 may further provide continuously updated data regarding space weather index values reached and may be configured in the smart contract to check at the expiration date of the contract for the index levels that were reached during the contract's duration, which may cause disbursement of the payout settlement at the expiration date.

The blockchain Oracle 202 may also be configured to check the space weather index levels at discrete intervals over the duration of the smart contract to provide multiple earlier opportunities for the contract to disburse a payout settlement, should the required parametric payout thresholds be met prior to expiration. By electing to add incremental blockchain Oracle checks throughout the duration of the contract, the hedge party increases the contract's efficiency by receiving an earlier self-executing parametric payout settlement disbursal which helps to mitigate against potential disruption to their business or operations that space weather conditions may have caused.

In some embodiments, the costs associated with the additional polling of the blockchain Oracle 202 may be borne by the hedge party. In some embodiments, the smart contract 204 may poll the blockchain Oracle 202 multiple times over the duration of the smart contract time period to determine if a payout condition has occurred.

In some embodiments, the smart contract between the hedge party and the risk party may establish peer-to-peer risk transfer agreements once written to the blockchain. The self-executing contracts may move the risk of space weather conditions from hedge parties to risk parties collectively and between the two parties in each smart contract, that is, between an individual hedge party and its associated risk party or parties. Once the contract is written to the blockchain, settlement that occurs at the expiration of the contract, or upon the detection of the occurrence of the trigger threshold(s) being met, automatically results in a parametric payout which may occur as a contractually agreed to transfer of digital currency. The transfer of the hedge premium from the Hedge Party is directly made to the Risk Party and, conversely, a potential transfer of risk coverage from the Risk Party to the Hedge party is also directly made by the contract's automatic self-executing parametric payout settlement logic.

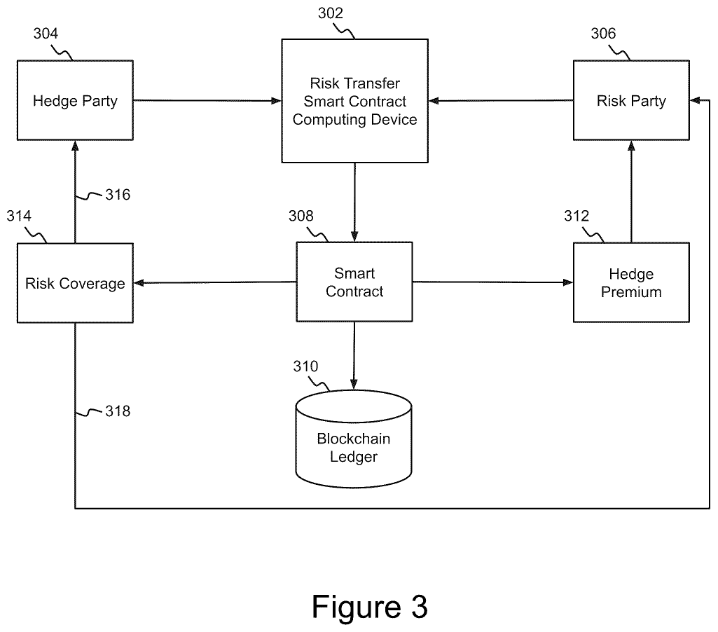

FIG. 3 depicts a space weather risk transfer system and method wherein a risk transfer smart contract (RTSC) computing device 302 may operate to “match” suitable complimentary orders from the hedge party 304 and the risk party 306 to generate a smart contract 308 that may be published to a blockchain ledger 310. The hedge party 304 may contribute the hedge premium 312 while the risk party 306 may contribute the risk coverage 314 to the smart contract 308.

In one embodiment, the risk party 306 may receive the hedge premium 312 at the beginning of the smart contract time period. The smart contract 308 may determine if the payout conditions were met wherein the hedge party 304 receives the risk coverage 314 if the payout conditions were met 316 or the risk party 306 is returned the risk coverage 314 if the payout conditions were not met 318.

In some embodiments, the disclosed and/or described Risk Transfer Smart Contract (RTSC) platform and method may include a plurality of thresholds for a single space weather index. In this embodiment, the hedge and risk parties would agree to parameters that included discrete amounts of risk coverage for each threshold included in the smart contract. For example, a smart contract could include a Kp index level of 9 with a specific risk coverage and a Kp index of level 8 with a lower amount of risk coverage, wherein the probability of a Kp index level of 9 being reached is lower than the probability of a Kp index level of 8 being reached. The hedge premium in this example embodiment would cover the increased risk that the risk party is accepting by agreeing to two space weather index levels with one being more likely to occur.

In some embodiments, the plurality of thresholds for a single space weather index may be combined with other space weather indexes that may or may not themselves have a plurality of thresholds. The advantage of having multiple thresholds is that it allows the hedge party to cover a distinct risk profile that hedges against both rare space weather conditions and more common space weather conditions. This arrangement also allows the risk party to receive additional hedge premium amount(s) from the more complex agreement by covering multiple risk scenarios. In some embodiments the Risk Party may agree to disburse back to the Hedge Party a portion of the hedge premium associated with the higher threshold condition if prior to the smart contract expiration a lower threshold condition occurs first, and the smart contract is automatically settled based on the lower threshold conditions.

In some embodiments, the digital currency used to represent the hedge premium and/or risk coverage amounts in a Risk Transfer Smart Contract (RTSC) may be a third-party digital currency such as the Ethereum cryptocurrency Ether (ETH), or a stable coin such as USDC, which is pegged to the US dollar. In some embodiments, the digital currency used in the RTSC may be the native digital currency used for a blockchain network's native smart contracts, such as using ETH tokens as the digital currency for a smart contract entered on the Ethereum Blockchain network.

In other embodiments, the native digital currency used for the smart contract hedge premium and risk coverage may be a third-party digital currency that is exclusive to the space weather Risk Transfer Smart Contract (RTSC) platform yet not exclusive to the Blockchain network it is entered onto, such as an as yet unspecified or presently undisclosed ERC-20 based digital currency used by the RTSC platform which is entered onto the Ethereum Blockchain network. This embodiment has the advantage of making the RTSC platform and its exclusive currency purpose built for the task of mitigating the potential financial losses from elevated space weather conditions yet utilizing well established and proven Blockchain networks.

As described, while one or more example embodiments disclosed and/or described herein refer to a token system implemented on the Ethereum blockchain using the ERC-20 standard protocol, embodiments are not limited to implementations on Ethereum or to any protocol but may be applied to other forms of decentralized application blockchain platform.

The disclosed and/or described risk transfer smart contracts and the resulting parametric payout settlements have advantages and efficiencies over existing risk transfer solutions such as conventional insurance and parametric insurance, while at the same time establishing targeted coverage for space weather conditions and the affected systems, devices, or infrastructure.

The Risk Transfer Smart Contract platform and approach presented herein allows parties seeking financial coverage against the damaging effects of elevated space weather conditions to eliminate a dependency on using a centralized insurance company that is encumbered by significant operational overhead and inefficiencies, as well as operating based on a different business model. In this regard, conventional insurance companies large enough to serve space weather insurance markets may have thousands of employees performing various functions including scientific experts, actuaries, programmers, and client facing sales professionals. The operational expenses of such an extensive insurance carrier workforce and necessary infrastructure is priced into client policy premiums and is borne by the client in the form of premiums that not only pay for risk coverage but the cost overhead of running the insurance carrier business itself.

By eliminating much (if not all) of the overhead of a conventional insurance carrier, hedge parties entering into risk transfer smart contracts as disclosed and/or described herein can avoid this overhead and directly engage with and enter into agreements with risk parties that agree to the conditions defined in the risk transfer smart contract, coverage offered, and premiums due for such coverage. Because the disclosed approach's smart contracts are self-directed and have no centralized party determining risk, coverage, premiums, or eligibility, the cost of risk is reflected more directly in terms of historical and/or scientifically established probabilities of such conditions being met within the contract period and results in reduced contract premiums.

The disclosed approach utilizes blockchain technology to guarantee proof of funds for the parties to a smart contract and enters the entire transaction on a public ledger for full transparency of digital currency funds committed in the contracts. Further, it utilizes an Oracle network which automatically settles the smart contract without further human intervention. This means that there is no need for the hedge party and risk party to trust or know details of each other's public identity. The anonymity of the hedge and risk parties to each other eliminates the possibility that certain hedge parties get overcharged for hedge premiums if their known identity or history would place them in a high-risk category (as may occur with conventional insurance products). Parties may additionally find the lack of public disclosure of RTSC platform use beneficial to their operations. Parties known for having assets in hard to insure regions of space such as low earth orbit (LEO) satellite providers would otherwise have difficulty procuring coverage for any in-orbit loss since they would be identified as hard to insure. The lack of asset or client screening in the disclosed embodiments is beneficial in procuring unbiased access to low-cost coverage.

The use of an Oracle network to access parametric data from a trusted source off-chain and feed that data back to the RTSC platform on-chain to settle a contract ensures automatic, rapid, and guaranteed parametric payouts to the hedge party if the conditions defined in the smart contract are met during the contract period. Once the smart contract is entered onto the blockchain structure the contract or payment schedule cannot be tampered with, delayed, modified, or disputed by a party.

Because the process of a parametric payout settlement is triggered automatically by the outcome of space weather conditions as reported by discrete space weather indices and is not based on submission of a claim, the process is data driven and not subject to human intervention. RTSC platform settlements are not reliant on an actual loss, not subject to interpretation, and are not subject to the potential delay or possible litigation associated with the conventional insurance claims process.

In one embodiment, the use of the RTSC platform guarantees the hedge premium agreed to by both parties is paid to the risk party as early as the moment the smart contract is entered onto the blockchain structure and is performed in near real-time.

The order and entry process of space weather smart contracts are self-directed and parameter based, and contracts are entered when contract orders from at least one hedge party and one risk party match each other's criteria, thereby eliminating unnecessary interaction with an insurance agent.

The disclosed approach ensures user asset security and confidence by utilizing user controlled, self-managed, and non-custodial external wallets, and as such does not require trust in a central authority to act as a custodian to hold or disburse funds prior to or at the settlement of a smart contract. A contract's fund disbursal(s) are made to the respective contract party wallets as defined by the RTSC platform.

The space weather risk transfer methods and systems disclosed and/or described herein isolate the risk of space weather conditions from the types of risks covered by conventional insurance carriers, thereby allowing for targeted coverage along with targeted premiums previously unavailable to asset owners affected by space weather conditions or events. Because the disclosed approach covers a single targeted aspect of risk associated with asset damage, the hedge premiums borne by hedge parties are determined solely by the risk for space weather conditions and not by the multitude of potential causes for loss (as typically found in conventional insurance policies for satellites or other systems or components that may be impacted by space weather).

Conventional space insurance providers may cover the risks associated with satellites including, but not limited to, loss of equipment due to space weather, liability for damage to third parties during launch, partial or total loss of satellite functionality due to equipment failure, loss from in orbit collisions, and loss from a shortened lifetime of the satellite. However, approximately only 1% of the satellites or assets in LEO space have any in-orbit coverage. The most common form of independent satellite insurance, when it is rarely offered is “launch plus one,” or the coverage of the launch of the satellite into orbit and one year of its operations. Launch plus one covers the highest-risk phase of a satellite's lifetime and may include loss, damage, or failure of satellite. This coverage begins at the initial ignition of the rocket through the separation of the payload from the launch vehicle and may include complete or partial failure of the satellite during the one-year coverage period. All of these risks may be bundled in a single policy, thereby significantly increasing the cost of coverage for such a policy versus the lower cost hedge premiums associated with the isolated space weather risk transfer solution disclosed and described herein.

In some embodiments, a space weather risk marketplace platform is created and provided to users, to enable users to create, enter into, and manage space weather risk transfer financial instruments in an efficient self-directed manner. The marketplace platform may provide contract relevant data and allow users to enter into space weather risk transfer smart contracts (RTSC) by either creating new or accepting existing risk transfer orders. The users' expenditure of time and administrative workload is greatly reduced through one or more marketplace efficiencies including but not limited to quick order browsing allowing of a public order book of open hedge and risk orders for fast contract entry, risk mitigation dashboards assisting in the analysis and management of user risk exposure and market order splitting (MOS), which can increase order matching on larger orders resulting in greater contract entry.

Since no third-party human assistant representing a centralized authority dictating contract pricing or eligibility is needed, the marketplace allows for quick and timely direct operation between both hedge and risk parties, putting the control of risk transfer contract entry into the hands of the marketplace user as facilitated by the marketplace user centric functionality. This is in contrast to being subject to the high friction delays or denials in seeking coverage from a conventional central authority that imposes limited business hours on users and heavily screens users seeking coverage. Such a conventional arrangement would make the immediate entry into contracts based on short windows of environmental event predictions impossible. An example is a weather authority predicting an extreme weather event in the next 24 hours leaving the hedge user unable to enter into a risk transfer smart contract in time using conventional solutions. In contrast, the disclosed RTSC computing device is integrated into the marketplace platform and performs most (if not all) the requisite functions, facilitating rapid and frictionless entry into risk transfer smart contracts.

In some embodiments, the marketplace platform may be cloud based and comprise at least one server with at least one database. The cloud resident database may further include one or more well-known databases (such as a SQL database) or a fixed content storage system to store (as non-limiting examples) content, user profile information, contract orders, configuration information, or administration information as necessary to execute the cloud service(s). In some embodiments, one or more networks providing computing infrastructure on behalf of one or more users may be referred to as a cloud, and resources may include, without limitation, data center resources, applications (e.g., software-as-a-service or platform-as-a-service) and management tools.

In this way, and in accordance with one or more embodiments, users may control, initiate, and engage in self-directed risk transfer smart contracts efficiently without a required understanding of the underlying hardware and software necessary to interface, communicate, manipulate, and exchange information and/or data necessary to deliver such services. In some embodiments, the space weather risk marketplace platform has global reach via internet connectivity and allows a global market of hedge and risk parties deemed eligible for RTSC participation by the marketplace platform's customer due diligence (CDD) process to participate in RTSCs.

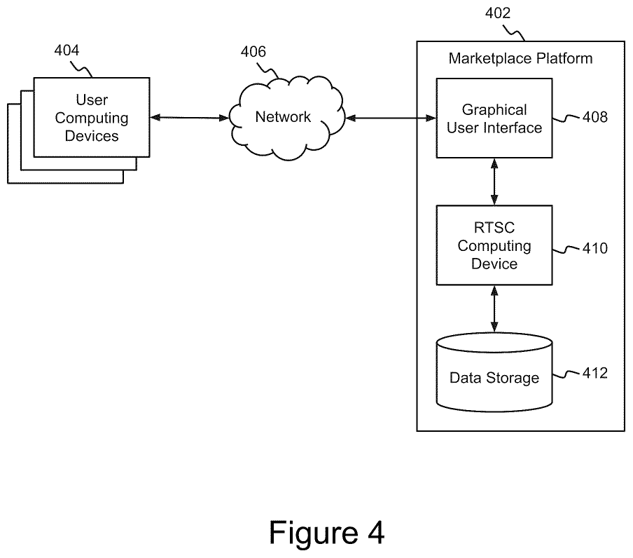

FIG. 4 depicts a marketplace platform system and associated methods wherein the marketplace platform 402 may connect, via one or more network interfaces on the RTSC computing device (which may be a processing component such as a server) 410, to at least one user computer device 404 of a plurality of user computer devices, over a network connection (such as the Internet) 406 via a graphical user interface 408. The user computing device 404 may be a static or mobile computing device of any suitable type, such as a mobile computer or a mobile computing device (for example, a tablet computer, a personal digital assistant, a laptop computer, a notebook computer, or a netbook), a mobile phone (for example, a smart phone), a wearable computing device (for example, a smart watch or smart glasses) or other types of mobile device, or a static computing device, such as a desktop computer or PC (where all are provided as non-limiting examples). The marketplace platform 402 may store information such as user profile information, contract orders, configuration information or administration information (as non-limiting examples) in a data storage 412 device or cloud database service.

In some embodiments, a party or user wanting to participate in space weather risk transfer smart contracts may be required to engage with a Customer Due Diligence (CDD) process to establish eligibility for participation. The CDD process of approving a user may include, but is not limited to, Know Your Customer (KYC), Anti-Money Laundering (AML), and accreditation checks that may be performed by a third-party agency or agencies.

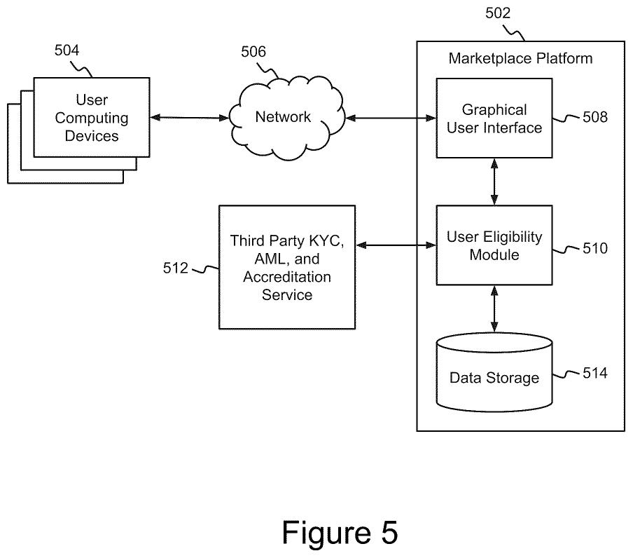

FIG. 5 depicts a Customer Due Diligence (CDD) and user eligibility verification system and associated methods wherein a marketplace platform 502 may receive (via one or more network interfaces on a marketplace platform computing device) from at least one user computer device 504 of the plurality of the user computer devices, over a network connection (such as the Internet) 506 via a graphical user interface 508, a request to join the platform to be eligible to participate in Risk Transfer Smart Contracts (RTSC). In some embodiments, the user eligibility module 510 may receive the request and transmit the data, via one or more network interfaces, to a Third-Party KYC, AML, and Accreditation Service 512 which may process the request and transmit the results to the user eligibility module 510.

The user eligibility module 510 may transfer the results of the KYC, AML, and Accreditation verification, through one or more network interfaces via a graphical user interface 508, to the user computing device 504. The market platform computing device may store the user-specific results of KYC, AML, and Accreditation verification information in a data storage 514 device or cloud database service to allow verified/approved users to connect to the marketplace platform 502 and participate in RTSCs.

In an example embodiment, the marketplace platform computing device 502, including at least one processor in communication with at least one memory device, may receive from at least one user device 504 requisite identifying data entered by the user via a graphical user interface (GUI) 508. The at least one marketplace platform computing device 510 may transmit, via one or more network interfaces, the received data to at least one accreditation agency to perform KYC, AML, and accreditation checks. The marketplace platform computing device 510 may receive, via one or more network interfaces, the results of the KYC, AML, and accreditation checks and update the marketplace platform computing device user identifier database with a designation of eligibility or ineligibility, thereby approving or denying RTSC participation on the marketplace. The marketplace platform computing device may transmit the eligibility results via a GUI 508 to a user device 504.

The concept of trustless-ness is a core element of blockchain, crypto payments, and smart contracts. “Trustless” means owners of digital currencies do not have to trust a third party such as a bank, a person, or an intermediary situated to operate between the owner and the owner's cryptocurrency transactions or holdings. A trustless crypto wallet may be referred to as a non-custodial or self-custody crypto wallet. On the other hand, a custodial wallet is not generally considered trustless. In that situation, users are trusting the “custodian” or third party to hold assets on their behalf.

A non-custodial marketplace platform ensures that users are protected from the potential shortcomings of custodial platforms, in which users rely on a custodial third party to ensure security and access to users' cryptocurrency holdings. These shortcomings may include but are not limited to situations where third party failures or mismanagement of custodial wallets may result in a user's held assets being frozen or made unavailable. Since cryptocurrency holdings are not insured by the Federal Deposit Insurance Corporation (FDIC), users do not receive protection from the FDIC in the event of third-party crypto currency custodial failures.

In one exemplary embodiment, the marketplace may rely on the connection of users' non-custodial, or self-custody wallets, where the wallet owner is fully responsible for managing their own digital currency funds. The user has full control of their crypto holdings, manages their own private keys, and handle transactions themselves. In some embodiments, a plurality of cryptocurrency wallets may be connected to the marketplace platform 502 to allow users to create orders and enter into smart contracts to seek or offer coverage for space related risks.

In one exemplary embodiment, the marketplace may not support the creation of marketplace custodial wallets and therefore may not hold a user's digital currencies or funds on the user's behalf. Marketplace authenticated users retain control of their cryptocurrency wallets and digital currency assets while connected to the marketplace platform, as each user retains full control of the private keys associated with their self-managed cryptocurrency wallet. The private keys are not shared with the marketplace platform or anyone else to create orders and/or enter into smart contracts.

In one embodiment, the risk transfer smart contract (RTSC) computing device, including one processor in communication with one memory device, may receive, via one or more network interfaces from at least one user computing device, a request to connect to a cryptocurrency wallet from an authenticated user. The RTSC computing device may then acknowledge the connection of the wallet to allow the user to create orders and enter into smart contracts. When an order is matched, digital currency funds may be transferred from the users' respective cryptocurrency wallets in the amounts specified by the agreement into a specified address controlled by the smart contract and the smart contract is written to the blockchain structure by the RTSC computing device.

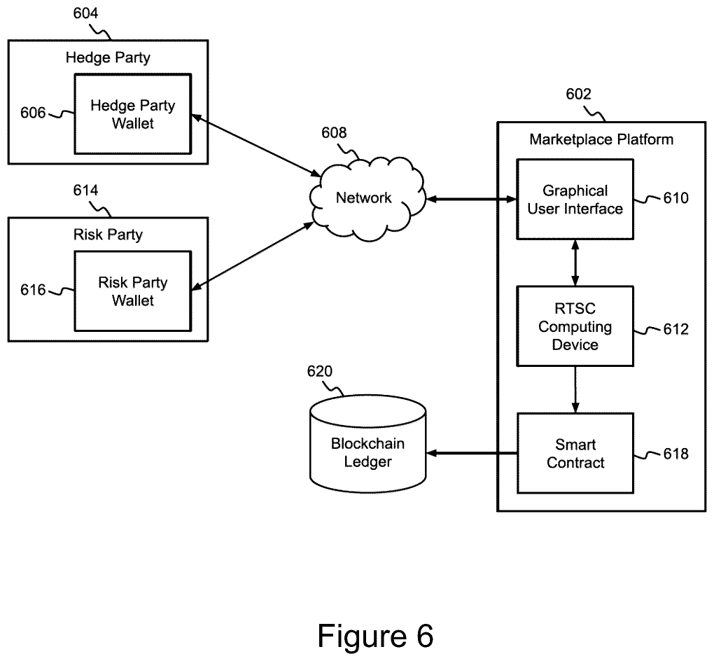

FIG. 6 illustrates a non-custodial marketplace for risk transfer smart contracts, wherein the marketplace platform 602 may receive a connection request from a hedge party 604 to connect to their hedge party wallet 606 over a network connection (such as the Internet) 608 via a graphical user interface 610, and wherein the hedge party wallet 606 may connect to the Risk Transfer Smart Contract (RTSC) computing device 612 for the purpose of entering hedge order parameters for a potential smart contract. The marketplace platform 602 may receive a connection request from a risk party 614 to connect their risk party wallet 616 over a network connection (such as the Internet) 608 via a graphical user interface 610, and wherein the risk party wallet 616 may connect to the RTSC computing device 612 for the purpose of entering risk order parameters for a potential smart contract.

The RTSC computing device 612 may identify a hedge order and a risk order with complimentary parameters (i.e., matching or compatible) and then may match the two orders to generate a smart contract 618 with the parameters agreed upon by both parties when they submitted their respective orders. The RTSC computing device 612 may publish the generated smart contract 618 into or on a blockchain structure 620 and may inform the hedge party 604 and risk party 614 that the smart contract 618 has been published into or on a blockchain ledger 620.

Anonymity is generally unacceptable in a system with Know Your Customer (KYC) and Anti-Money Laundering (AML) regulatory requirements. Even if every entity was vetted for eligibility before being able to participate, each participant needs to have an irrefutable guarantee of the identity of the parties they are interacting with. Existing risk transfer solutions such as conventional insurance may employ a risk profile for clients that can adversely affect the premiums they pay for insurance coverage, which in some cases increases premiums to such a degree as to prohibit such clients from securing the desired coverage for assets.

A commonly appreciated alternative is “pseudonymity,” wherein the identity of the participant is not known to peers, who are not authorized to know, but instead there exists a central entity which is able to deanonymize the pseudonym in case of a dispute. In some embodiments, the disclosed marketplace platform may provide a pseudonymous method for hedge and risk parties to enter into smart contracts without knowing each other's identities, thereby removing the Risk Transfer hedge premium penalty associated with some higher risk profile hedge parties.

Since the risk transfer marketplace 602 may offer parametric based Space Weather risk transfer smart contracts, the public risk profile of a hedge user is irrelevant to the risk party since the risk assessment of an individual RTSC is made based on defined space weather conditions occurring, and not on the risk profile of the hedge user or their assets. The marketplace platform may know all the participants due to KYC, AML, and accreditation checks being performed before users are deemed eligible and permitted to enter into smart contracts. In these embodiments, the centralized platform may use a third-party accreditation agency to ensure all participants are vetted but the identity of each user is not known to other users.

The approach disclosed and/or described herein allows hedge parties and risk parties with no knowledge of each other to utilize the marketplace platform to efficiently and confidently engage in secure, transparent, risk transfer smart contracts (RTSC) that rely on the trustless nature of blockchain technology. Blockchain facilitates such RTSCs providing the necessary guaranteed proof of funds, trusted Oracle blockchains and sources of settlement data, as well as the automatic self-executing disbursals of hedge premiums and parametric payouts. This is achieved without the trust level that would be required by both parties when engaging with solutions that use third party human intervention to screen, verify or approve these aspects of a risk transfer arrangement. This allows for a unique trustless relationship between both hedge and risk parties engaging in space weather risk transfer activities.

In some embodiments, the marketplace platform may allow hedge parties and risk parties to create discrete hedge orders and risk orders. In one embodiment, the risk transfer smart contract (RTSC) computing device, including at least one processor in communication with at least one memory device, may receive via one or more network interfaces, from a plurality of user devices, hedge orders and risk orders entered by the respective hedge parties and risk parties via a graphical user interface (GUI). Each order may consist of at least (but is not limited to) the parameters of RTSC time period, hedge premium, risk coverage, and space weather index thresholds that define the payout conditions. The RTSC computing device may retrieve the entered orders and perform one or more functions or operations to match compatible hedge orders and risk orders. The matching of complimentary/compatible risk orders and hedge orders may be done based on the sequence in which orders were submitted to facilitate an equitable process of matching and smart contract creation.

In an alternative embodiment, the priority of which orders are matched may be based on one or more other factors such as risk coverage amount, length of time, seniority of users, amount of digital currency held, or other factor. The RTSC computing device (after matching complimentary orders) may then publish the resulting smart contracts to a data storage structure such as a distributed ledger.

Further, Market Order Splitting (MOS) (a system and method of splitting larger hedge orders into smaller orders that may be matched for smart contract generation) allows or results in a greater likelihood of order matching to smaller risk orders that have insufficient risk coverage to match 100% of the risk coverage sought in the MOS hedge order. This additional matching may result in providing additional contract flexibility and liquidity to marketplace parties.

In some embodiments, the process of entering into risk transfer smart contracts to either hedge against or to provide risk capacity for space weather conditions on the marketplace platform may be automated based on platform users that have elected to authorize the platform's automatic creation of orders on their behalf based on predetermined order criteria parameters. For one or both hedge and risk users, the process may involve creating a contract order profile of one or more predetermined user defined contract parameters that indicate the acceptable terms for entering into marketplace (automatically) generated smart contracts on their behalf. The users may set one or more RTSC order parameters including but not limited to the time periods, the space weather index thresholds, the hedge premium, the risk coverage, and the acceptable combinations of those and or other available contract parameters. The order parameters may be set as discrete ranges of acceptable contract terms or values to create a greater likelihood the automated matching process results in a RTSC order of acceptable terms for both parties.

In some embodiments, the marketplace platform may automatically generate orders on behalf of a user that has elected to authorize the platform to create orders on their behalf based on user defined acceptable contract parameters. These are matched with existing compatible submitted orders identified on the platform from other users. In another embodiment, the marketplace platform may automatically generate orders on behalf of a user that has elected to authorize the platform to create orders on their behalf based on user defined acceptable contract parameters when there are no existing compatible submitted orders of the other party type identified on the platform. In this case, upon creation of the auto generated order, the marketplace platform may display it publicly on the platform GUI to allow other parties to browse and manually accept the terms of the order.

In yet another embodiment, the marketplace platform may automatically generate orders on behalf of users that have elected to authorize the platform to create orders on their behalf based on user defined acceptable contract parameters when it detects that at least two users with compatible user defined contract parameters are identified, which may result in both the automatic creation of the orders as well as the resulting risk transfer smart contract.

In some embodiments, the risk-transfer smart contract (RTSC) computing device, including at least one processor in communication with at least one memory device, may receive, via a one or more network interfaces from at least one a user computing device, input from a user indicating the smart contract parameters that are acceptable for entering into smart contracts. The RTSC computing device may automatically create hedge or risk orders based on the platform user's predetermined parameters to place in a queue waiting for a complimentary party to match with the generated orders. The RTSC computing device may also automatically generate an order and enter into a RTSC if it detects a complimentary order has been created within the preset parameters. Finally, the RTSC computing device may determine that two users with preset parameters for entering into smart contracts have matching parameters and then automatically generate the required complimentary orders and create the resulting RTSC.

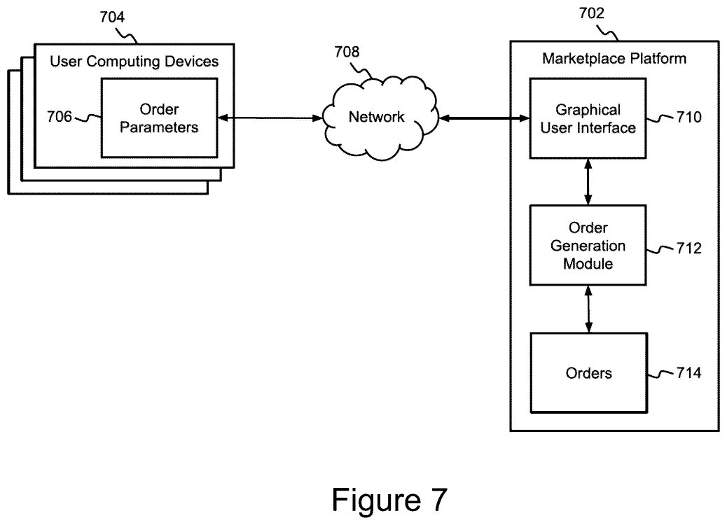

FIG. 7 illustrates an automated order entry system and method wherein the marketplace platform 702 may receive via one or more network interfaces on the marketplace platform computing device, from at least one user computer device 704 of the plurality of the user computer devices, a set of order parameters 706 for creating Risk Transfer Smart Contracts (RTSC), over a network connection (such as the Internet) 708 via a graphical user interface 710. In some embodiments, an order generation module 712 may generate orders 714 based on one of three discrete scenarios, wherein: 1) orders 714 may be generated to match with existing compatible orders identified on the platform submitted by other users; 2) orders 714 may be generated when there are no existing compatible orders submitted by other users identified on the platform, and upon creation of an auto generated order, display it publicly on the platform GUI 710 to allow other parties to browse and manually accept to the terms of the order; or 3) orders 714 may be generated when the order generation module 712 determines that at least two users with compatible user defined contract parameters are able to be identified, which may result in both the automatic creation of the orders as well as a resulting smart contract.

In some embodiments, the marketplace's smart-contract database of previously generated smart contracts may be analyzed to extract relevant market data about prevailing space weather risk transfer parameters. The marketplace platform may display one or more active smart contracts with their parameters as well as historical smart contracts with their parameters and settlements.

The amount of demand for space weather risk transfer for both hedge and risk parties may be shown as a type of market depth indicator to provide real time and historical information about the space weather risk market. This may be valuable as market depth helps to graphically illustrate the overall level and breadth of open orders, prevailing parameter values, and market demand. This information may inform platform users' decisions to enter into space weather risk transfer smart contracts and provide insight into the pricing of risk transfer that the market has demonstrated.

In some embodiments, the marketplace platform may maintain a continuously updated dashboard of space weather conditions. The data may include historical space weather data, near real-time data, and forecasts of future space weather conditions. The information on space weather may be provided as past, current, and future space weather index levels which may include, but are not limited to, Planetary K-Index (Kp), F10.7 Index, and Disturbance Storm Time Index (Dst).

The displayed information may be sourced from various international space weather agencies such as the Space Weather Prediction Center (SWPC), which is part of the National Oceanic and Atmospheric Administration (NOAA), or other trusted source(s). The marketplace platform may provide graphical representations of various space weather indices, may allow users to search through historical data, and may provide historical probabilities for specific space weather index levels to assist users in the efficient analysis of space weather conditions for purposes of deciding on whether to engage in seeking a RTSC.

In some embodiments, the costs of engaging in space weather risk transfer smart contracts (RTSC) may be determined by the market of users based on the sentiment regarding the (historical) odds of particular space weather index levels being reached, and/or the near-term forecasts of predicted space weather conditions. The costs of space weather risk transfer are reflected in the hedge premium relative to the amount of risk coverage provided. For RTSCs, the odds of a defined space weather index level being reached may be used to inform the base calculated ratio of hedge premium as relative to the risk coverage sought or provided. For example, if a specific space weather index value has a 10% probability of occurring during the time period of the RTSC, then the hedge premium will have a default calculated cost of 10% of the risk coverage amount sought/provided. If the coverage amount sought in this example is $1 MM, the hedge premium would default to $100 k.

In some embodiments, for RTSCs with a time period of weeks or months, the historical space weather index probabilities may be used as the primary determining factor in the costs of engaging in space weather RTSCs. For example, the probability of a Kp index value of 9 being reached is about 38% per year when averaged over the whole solar cycle but with greater probability closer to the solar maximum and lower probability at the solar minimum.

For RTSCs with a shorter time period, such as a few days or a week, near-term forecasts of predicted space weather conditions may be the primary factor in determining the costs of engaging in space weather RTSCs. In some cases, both the historical space weather index probabilities and the near-term forecasts may be used as factors in assessing the costs of engaging in space weather RTSCs. This may be a result of the presence of near-term forecasts for above normal space weather conditions that suggest a higher near-term risk than the historical long-term risk might suggest over the specific time period of a smart contract.

In some embodiments, risk coverage users may enter into their RTSC orders a hedge premium adjustment value as a variable that functions to either increase or decrease the required hedge premium required for the risk party to provide the hedge user's desired risk coverage. This acts to modify a standard hedge premium calculation which may be based on a combination of near-term and historical probabilities. The use of the hedge premium adjustment variable in RTSCs enables greater adaptation to the use of the platform's market for the pricing of an order.

“Gas” in the context of a blockchain transaction is a fee required to successfully conduct a single transaction, such as executing a contract on the Ethereum blockchain platform. Other layer 1, layer 2 or layer 3 networks may impose similar transaction gas costs within their respective blockchain networks.

In an example of using the Ethereum Blockchain, gas fees are priced in fractions of the cryptocurrency Ether (ETH) in denominations called gwei. Gas is used to pay validators for the resources needed to conduct transactions on the blockchain network. The amount of gas required is determined by supply, demand, and network capacity at the time of the transaction.

In some embodiments, the blockchain network used for the risk transfer smart contracts (RTSC) or the underlying layer 1 blockchain, for example Ethereum (ETH), may require that gas fees be paid. In one embodiment, the blockchain for the RTSCs may be a layer 2 blockchain or sidechain that lays on top of a layer 1 blockchain with access to an off-chain data Oracle. The underlying layer 1 blockchain may require that the native crypto currency of the blockchain be used to pay for gas fees associated with transactions conducted on that layer 1 network.

In addition, the layer 2 blockchain or sidechain, for example Polygon, may require that the native crypto currency of the layer 2 blockchain or sidechain (e.g., POL) be used to pay for gas fees associated with transactions conducted on that network, and the off-chain data Oracle may require that the Oracle cryptocurrency, for example Chainlink (LINK), be used to pay for gas fees associated with transactions occurring on the Chainlink network.

The flexibility in allowing the hedge party to determine how many times to poll the data Oracle during the smart contract's duration creates a potential for extra gas fees being incurred. In one embodiment, the marketplace platform may assist users in navigating the issue of ensuring sufficient gas fees through an automated process and function, hereinafter called the gas estimation module (GEM).

The GEM may function to estimate the amount of gas required over the RTSC time period based on historical and current gas prices and thereby assist in the estimation of future gas costs for both the layer 1 and layer 2 cryptocurrencies, and for the Oracle cryptocurrency, as well as factor in user elected options such as the number of Oracle data checks to be conducted over the duration of the RTSC. The GEM and its processes benefit both parties of the RTSC by ensuring to the users they have sufficient cryptocurrency available in all the necessary forms to pay for the gas fees required to execute the RTSC and conclude the settlement efficiently.

As a non-limiting example, the GEM may operate to obtain current gas costs for different transactions on a specific blockchain network (e.g., Ethereum, Chainlink, or others) from internet sources that track gas costs (as an example, see https://www.blocknative.com/gas-estimator). An internal algorithm or other process may be used that looks at historical and current gas prices to estimate the amount of gas that will be required at the time the transactions are scheduled to be performed (e.g., at the end of the smart contract time period).

The GEM may estimate the future prices but require a digital currency buffer to better ensure costs can be covered and that the transactions can be executed. The GEM will also monitor existing contracts and message users if the amount of gas included in a smart contract is insufficient due to a spike in gas prices, thus giving the user an opportunity to add more cryptocurrency to cover the expected gas costs. In one embodiment, surplus gas fees committed to a contract that are unused during contract operation and settlement may be returned to the users committing the surplus gas fees, provided those surplus gas fees exceed the transaction costs of returning the surplus to the user.

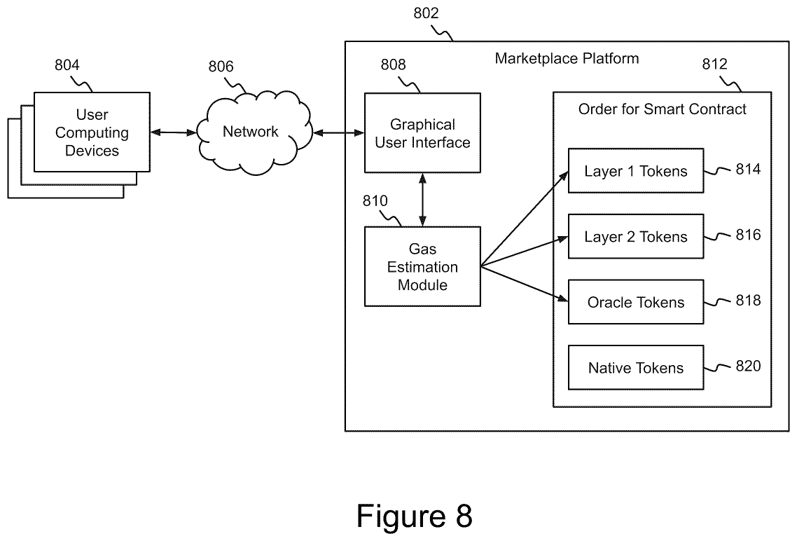

FIG. 8 illustrates a cryptocurrency gas estimation system and method wherein the marketplace platform 802 may receive via one or more network interfaces on the marketplace platform computing device 802, from at least one user computer device 804 of the plurality of the user computer devices over a network connection (such as the Internet) 806 via a graphical user interface (GUI) 808, a request for the gas estimation module (GEM) 810 to calculate the cryptocurrency gas fees associated with a smart contract order 812. The underlying layer 1 blockchain, for example Ethereum (ETH), may require that the native crypto currency of the blockchain, that is, the layer 1 tokens 814, be used to pay for gas fees associated with transactions conducted on that layer 1 network. In addition, the layer 2 blockchain, for example Polygon (POL), may require that the native crypto currency of the layer 2 blockchain, that is, layer 2 tokens 816, be used to pay for gas fees associated with transactions conducted on that network. The off-chain data Oracle network, for example Chainlink may require that the native Oracle cryptocurrency (LINK), that is, Oracle tokens 818, be used to pay for gas fees associated with transactions occurring on the Chainlink network.

The native cryptocurrency used to contribute hedge premiums and risk coverage in the order for smart contract 812, that is RTSC specific (Native) tokens 820, used to pay for the hedge premiums and risk coverage associated with the smart contract are not used for gas purposes, though the act of placing the smart contract onto a layer 2 blockchain network's ledger, requires the use of that blockchain's native crypto currency, that is, layer 2 tokens 816, for that transaction's gas fee.

Each risk party that provides risk coverage in the form of a digital currency to a hedge party in a RTSC is exposed to potential cryptocurrency loss should the RTSC payout conditions be met and result in the automatic parametric payout settlement and disbursal of the risk coverage amount provided in the RTSC to the hedge party. The statistical probability of an RTSC resulting in a parametric payout settlement of risk coverage to a participating hedge party depends on the variables specific to each RTSC, including but not limited to (or required to include) space weather index levels selected, if there are near-term predictions of strong conditions prior to or after a contract has been entered, the length of a contract, and how close or far from the solar activity maximum within the solar activity cycle that a contract is active. As will be understood, some RTSCs are more likely to result in a payout condition being met while other RTSCs are relatively unlikely to result in a payout condition being met, for example when providing coverage for a very low probability and exceptionally strong space weather event without near-term predictions.

In some embodiments, the disclosed and/or described marketplace platform may provide users a dashboard to assist in the management of their marketplace portfolio of RTSCs by providing a way to illustrate their entire account exposure to the risk of loss of digital currencies used in their portfolio's active RTSCs. The dashboard (or other form of interface) may provide information that shows the potential risk exposure levels over time given specified space weather index thresholds being met. The dashboard may include graphical and analytical elements to make the task of managing account risk easier while making time spent on the marketplace platform more efficient.

The dashboard may include user account risk exposure limits that can be set to provide warnings about the account's potential exposure to financial loss when creating new orders and when setting parameters for automated order creation. The warnings may provide a link to adjust risk exposure limits to proceed or may simply be informational in nature.

In some embodiments, the risk party of an existing RTSC may want to reduce their existing risk exposure in an active contract. Since contracts cannot be cancelled, the risk party has the ability to offset the risk of the original contract by entering into a second comparable contract as the hedge party in order to nullify the risk exposure of the original contract. The combination of the two RTSCs, one entered into as a risk party and the other entered into as a hedge party, using the same settlement thresholds, effectively cancel each other's risk.

In another embodiment, the risk party of an active RTSC may also enter into a second RTSC as the hedge party to partially offset the risk of the existing RTSC, whereby the second RTSC limits the total risk exposure of the first RTSC. For example, a risk party may want to retain the low-probability risk portion of an existing RTSC by taking a second RTSC as the hedge party that offsets a portion of the high-probability risk of the first RTSC. Alternatively, a risk party may want to retain the high-probability risk portion of an existing RTSC by entering into a second RTSC as the hedge party that offsets a portion of the low-probability risk of the first RTSC.

In some embodiments, when a RTSC between a hedge party and risk party reaches the end of its time period or expiration date without having met the space weather conditions necessary for triggering a payout of Risk coverage to the hedge party, an automated notice may be sent to both parties with the option to enter into a new RTSC with the same parameters, including renewed contract length of time, as a way to facilitate efficient RTSC renewal. If both parties agree to enter into the new suggested RTSC, then new orders may automatically be generated when the users connect their cryptocurrency wallets to the marketplace platform and a new RTSC is created.

In some embodiments, the automated notice may be sent in a number of ways including but not limited to email, text message, or a pop-up reminder seen in the marketplace platform's user profile. The notice may contain a secure link to the marketplace order entry interface that allows users to efficiently review the new RTSC which users can simply click/select to agree to the terms. The notice may contain a time limit within which the link must be clicked and may further contain a time limit within which the cryptocurrency wallet must be connected to the marketplace platform, as well as require validation of sufficient cryptocurrency funds.

In one embodiment, a risk sharing system and method allows single hedge orders to be split up by the marketplace platform into multiple discrete hedge orders, thereby allowing more than one risk party to share the total risk coverage sought by the hedge party. This process or function is referred to as market order splitting (MOS) herein. A MOS hedge order treats the risk coverage variable entered by the hedge party as a goal and not a requirement. A MOS hedge order may be split up into as many discrete hedge orders as are sufficient to collectively meet the risk coverage sought if the first matching risk coverage order does not provide 100% of the risk coverage sought in the order. As additional discrete risk orders from the decentralized community of risk parties on the marketplace are found to match with the hedge order requirements and provide a portion of the original hedge order's sought risk coverage, the marketplace platform automatically matches the compatible orders and publishes discrete RTSCs onto the blockchain structure. These active RTSCs are grouped or bundled in the hedge party's account dashboard for more efficient monitoring and management.

In one non-limiting example, a MOS hedge order seeking $40M in coverage priced in digital currency may eventually be 75% subscribed across 3 risk parties resulting in $30M in risk coverage priced in digital currency being provided across 3 active RTSCs. In this example, the hedge party benefits from having at least $30M of risk coverage priced in digital currency versus having no coverage at all, as well as being required to pay 75% of the original MOS order's hedge premium. The MOS capability allows for market efficiencies beneficial to both hedge and risk parties that result in RTSCs that would not be possible if the hedge order required a 100% match for the risk coverage sought and there were insufficient risk coverage funds available by a single participating risk party.

In some embodiments, an open standard hedge order may be converted by the hedge party if they elect to convert the standard order to a MOS order. In some embodiments, a hedge party with a partially unsubscribed MOS order may cancel the remaining unsubscribed order portion.

In some embodiments, the RTSC computing device may receive, via one or more network interfaces from at least one user computing devices, input from a user indicating smart contract parameters for an MOS hedge order that are acceptable for entering into a smart contract. The RTSC computing device may automatically create hedge orders based on the platform user's predetermined and user defined order parameters to place in a cue waiting for an opposing risk party to match with the generated orders. The RTSC computing device may also automatically generate a hedge order and enter into a smart contract if it identifies a matching risk order has been created with compatible preset order parameters. Finally, the RTSC computing device may determine that other users with preset parameters for entering into smart contracts have matching parameters which results in the automatic generation of the required compatible hedge orders and creation of the resulting smart contracts.

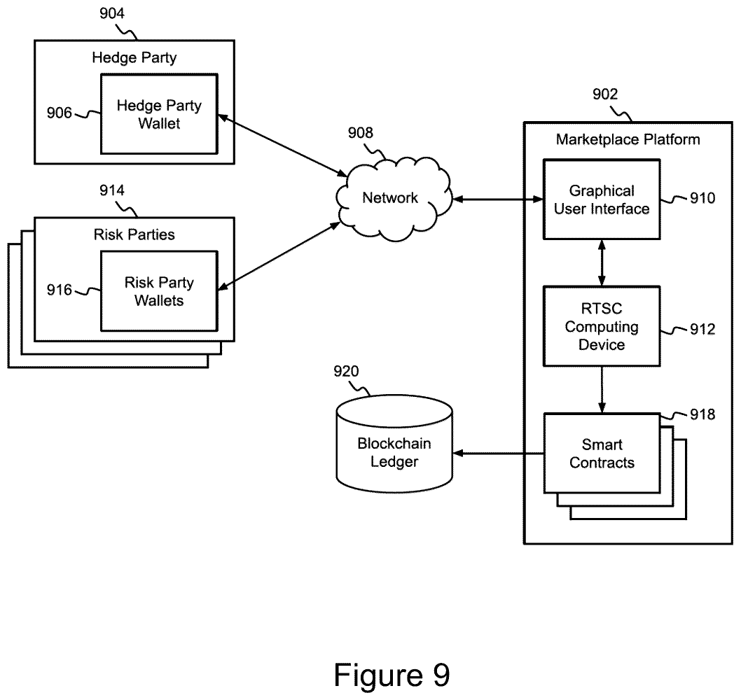

FIG. 9 illustrates a market order splitting (MOS) system and method wherein the marketplace platform 902 may receive a request from a hedge party 904 to connect their hedge party wallet 906, over a network connection (such as the Internet) 908 via a graphical user interface (GUI) 910, to the risk transfer smart contract (RTSC) computing device 912 for the purpose of entering a hedge order with an amount of risk coverage sought or for entering order parameters for a hedge order with an amount of risk coverage sought. In one embodiment, the RTSC computing device 912 may split the hedge order into multiple smaller discrete hedge orders. This may be done to enable matching with multiple risk parties 914 who have connected their risk party wallets 916 to the marketplace platform via a GUI 910 for the purpose of entering risk orders, where those orders provide risk coverage that is less than sought by the hedge order, or for entering order parameters for risk coverage that is less than sought by the hedge order. The RTSC computing device 912 may then create multiple smart contracts 918 that are published to the blockchain ledger 920. This allows the original hedge party order to be split into multiple smart contracts 918 which in aggregate provide partial to full coverage of the risk coverage originally sought by the hedge order.

In some examples, individual risk parties may have similar RTSC order parameters with other risk parties that have defined them in their individual contract order profiles. These risk parties with similar contract order profiles may be willing to provide risk coverage for specific high-demand forms of risk, for example providing risk coverage for a near Carrington-level event based on a Dst Index level of −800 nT.

These groups of risk parties effectively create virtual, self-administered risk pools for coverage of specific expressions of risk without centralized coordination or formation. These types of virtual risk pools are effectively crowd-sourced risk capacity pools that provide hedge parties with the ability to engage in space weather risk transfer for discrete types of risk. In such cases, the disclosed self-organizing market for space weather risk transfer may provide the capacity for risk coverage without the need for a centralized risk pool. The manifestation of self-organized and self-administered virtual risk pools may not preclude the participation of a centralized risk pool, but the market may not require one.

In some embodiments, risk party participation rewards in the form of digital currency or cryptocurrency may be provided to one or more risk parties to incentivize their participation in providing risk coverage in space weather RTSCs. The rewards may be denominated in the native cryptocurrency used for hedge premiums and risk coverage of the RTSC and may be expressed as an annualized percentage yield (APY). For example, the reward may be based on a 5% APY with the actual contract length and risk coverage amount provided determining the reward earned.

A pool of native cryptocurrency may be set aside by the marketplace platform for the express purpose of providing rewards to risk parties. The rewards earned by a risk party for providing risk coverage in a RTSC may have the effect of stimulating market participation for specific categories of space weather risk transfer. For example, the market for very low probability space weather conditions such as a near Carrington level event would have very low odds of occurring and thus have a relatively small hedge premium, whereas the rewards may then provide additional incentive for risk parties to engage in such contracts to provide the risk coverage for such a low probability event.

The rewards may make it more attractive for the risk parties to participate in RTSCs with unattractive odds or low premiums and at the same time make it beneficial for hedge parties, as incentives to the risk parties reduce the need for the hedge parties to adjust contract terms, for example by increasing the hedge premium offered to sufficiently attract risk party interest. Further, the purpose and benefit of offering a form of reward extends beyond providing short-term incentives for risk parties to participate in providing risk coverage; the rewards may stimulate marketplace adoption of both hedge and risk parties to the extent of establishing long-term captive participants engaging in space weather risk transfer and making the marketplace more likely to be self-sustaining once reward incentives are reduced or no longer provided.

In some embodiments, the RTSC computing device, may match a hedge order and a risk order together while providing rewards to the risk party. In some embodiments, the RTSC computing device may then include the reward pool as a third party in the RTSC and utilize the reward pool's blockchain address from which digital currency rewards can be directly disbursed to the risk party at the settlement of the RTSC. A RTSC with rewards would then consist of the hedge party, the risk party, and the reward pool party with settlement including disbursal of the reward from the reward pool party to the risk party not conditioned on the outcome of the automatic parametric payout settlement.

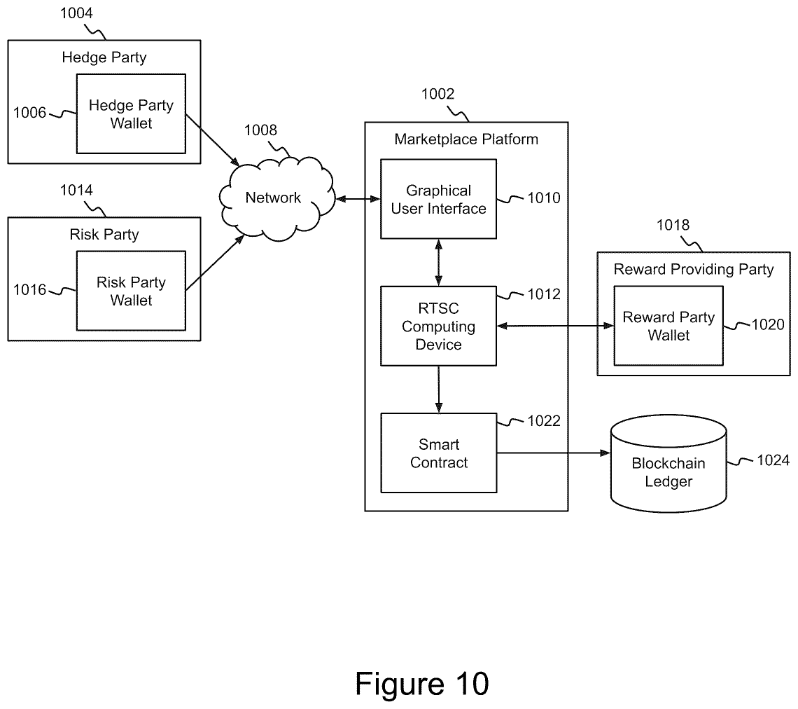

FIG. 10 illustrates a system and method to incentivize participation in providing risk coverage wherein the marketplace platform 1002 receives a request from the hedge party 1004 to connect their hedge party wallet 1006 over a network connection (such as the Internet) 1008 via a graphical user interface (GUI) 1010 for the purpose of submitting a hedge order to the risk transfer smart contract (RTSC) computing device 1012. Similarly, the marketplace platform 1002 receives a request from the risk party 1014 to connect their risk party wallet 1016 over a network connection (such as the Internet) 1008 via a GUI 1010 for the purpose of submitting a risk order to the RTSC computing device 1012.

In one embodiment, the RTSC computing device 1012 may receive a request from a reward providing party 1018 to connect their reward providing party wallet 1020 via one or more network interfaces for the purpose of providing a reward to the risk party 1014 in the form of the native cryptocurrency used for the hedge premiums and risk coverage used in the RTSC. The RTSC computing device 1012 may then generate a smart contract 1022 using cryptocurrency from the three connected wallets of the hedge party wallet 1006, the risk party wallet 1016, and the reward providing party wallet 1020, which is then published to the blockchain ledger 1024.

In one embodiment, the smart contracts may be configured to transfer rewards to the risk party at the end date of the smart contract time period. In an alternative embodiment, the blockchain Oracle may also be configured to transfer rewards to the risk party at discrete intervals over the length of the smart contract to provide continuous payments to the risk party, instead of receiving a lump sum at the end of the smart contract time period. For smart contracts over longer time periods, for example 12 months, the risk party may elect to have the smart contract transfer accruing rewards at predefined intervals to ensure a predictable payment schedule rather than wait until the end of the smart contract time period.

In some embodiments, the costs associated with the additional reward transfers may be borne by the risk party. In other embodiments, the costs associated with the additional reward transfers may be borne by the hedge party. For blockchain based systems, the costs associated with the transactions for transferring rewards may be priced in the native currency of the blockchain network used by the smart contract or in the underlying layer 1 blockchain, for example in Ether (ETH), and are referred to as gas fees.

In some embodiments, the marketplace platform may charge risk transfer smart contract (RTSC) service fees to parties entering into RTSCs. The contract service fees may be denominated in the RTSC's native cryptocurrency used for hedge premiums and risk coverage. In an alternative embodiment, the contract service fees may be denominated in another digital currency, for example Ether (ETH). The contract service fees are similar to brokerage fees in that they help cover the costs of executing transactions or providing specialized services on behalf of clients. In this regard, the marketplace platform is a specialized service that requires income in the form of RTSC service fees to cover the costs of its ongoing operations and administration.

In some embodiments, an application programming interface (API) may be provided to allow some users to access certain marketplace platform functionality without having to use the platform directly. An API is a way for two or more computer programs to communicate with each other. It is a type of software interface, offering a service to other items of software. A document or standard that describes how to build or use such a connection or interface is called an API specification. In contrast to a user interface, which connects a computer to a person, an application programming interface connects computers or items of software to each other. It is not intended to be used directly by a user other than a computer programmer who is incorporating it into other software. An API specification would enable some users to integrate core functionality such as logging in, connecting wallets, creating orders, setting automated contract parameters, and other functionality into their own systems, platforms, or services. Thus, a purpose of a marketplace platform API is to allow more sophisticated users to seamlessly integrate space weather risk transfer functions into their existing external platforms.

In some embodiments, the marketplace platform may include an administration panel accessible to the platform operator who maintains the marketplace platform and by extension the market for space weather risk transfer. The administration panel may facilitate the use of management software, business intelligence, analytics, models, prognostics or other advisory or information services and assist the platform operator in controlling and managing the marketplace platform. Functions or capabilities of an administration panel may include but are not limited to (or required to include) platform management software, managing rewards, adjusting contract service fees, managing user accounts after verifying KYC, accreditation and other compliance requirements, managing platform content, managing available features and functionality, and adjusting platform settings.

The disclosed and/or described marketplace allows for relatively agile and elastic risk capacity since it is based on a publicly anonymous community of accredited risk parties which in aggregate provide risk capacity that is not limited in the sense insurance companies are by defined underwriting limits for risk coverage. As a result, the hypothetical total risk coverage generated through the marketplace can exceed the risk capacity offered by a single or even multiple insurance companies by leveraging the power of distributed, accredited, and crowd sourced risk capacity.

The eligibility of participation as a risk party is typically a straightforward process of passing third party KYC, AML and accreditation checks by the marketplace, making the opportunity of accredited parties to enter into the market of risk transfer fairly simple and straightforward. Because marketplace users are anonymous with respect to each other there are no hedge premium penalties for hedge parties that would otherwise be classified as a high risk. The anonymity of both parties with respect to each other ensures there is no user or asset bias against hedge parties which allows for their frictionless access to risk coverage opportunities.

The disclosed non-custodial marketplace platform is trustless as marketplace users do not have to trust a third party with holding the keys to their cryptocurrency assets. The marketplace allows users to remain fully in control of their assets by allowing them to use their own non-custodial self-managed cryptocurrency wallets for which they hold the keys, thereby maximizing a user's digital currency or cryptocurrency asset security.

Market Order Splitting (MOS) of hedge orders allow hedge orders to be submitted with a risk coverage goal instead of a requirement, allowing hedge parties to potentially receive at least fractional coverage for orders that would have otherwise not resulted in a matched complimentary order and resulting contract. This can provide additional contract flexibility and liquidity to marketplace parties.

In some embodiments, the self-directed nature of marketplace participation is supplemented by providing guidance to users to efficiently perform marketplace tasks through use of both graphical and written guidance to help manage the full lifecycle of a contract from order entry through settlement and contract renewal.

The disclosed marketplace platform facilitates the creation of risk transfer smart contracts (RTSC) whereby the platform is able to automatically match (or match within pre-determined characteristics) complimentary hedge party and risk party orders in near real-time. This capability allows the platform to create smart contracts that meet the risk transfer needs of both parties with a minimum of user activity and time. The disclosed and/or described marketplace platform thus provides an efficient and targeted solution to the problem of space weather risk transfer by allowing for reduced costs for risk coverage due to the isolated risk being covered.

In one embodiment, the marketplace platform provides KYC, AML, and accreditation verification so while parties are anonymous with respect to each other and maintain public privacy, the marketplace “knows” enough about their identities to comply with jurisdictional authorities' compliance requirements and practices.

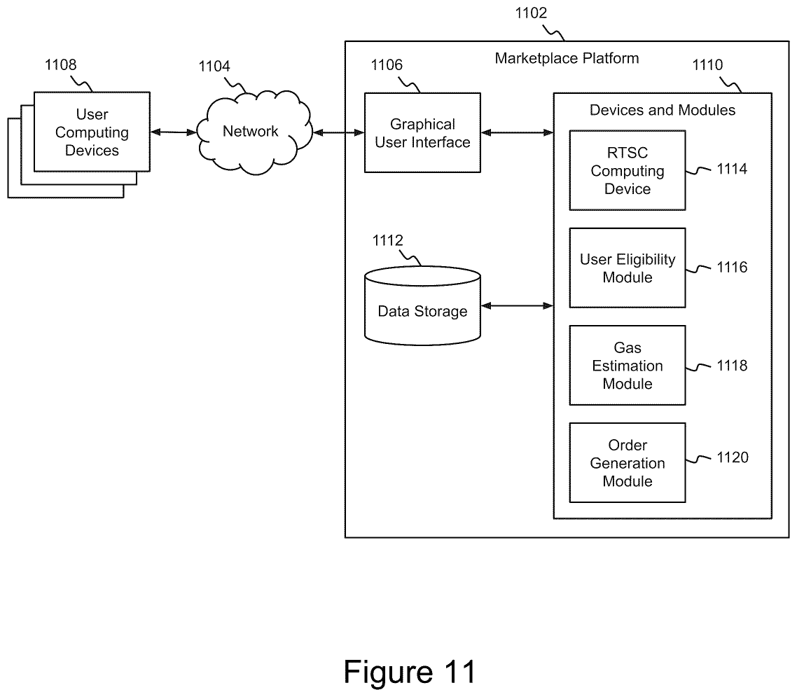

FIG. 11 illustrates a marketplace platform system and method wherein the marketplace platform 1102 receives over a network connection (such as the Internet) 1104 via the graphical user interface (GUI) 1106 a request from at least one user computing device 1108 among the plurality of user computing devices to interact with the marketplace platform 1102. Platform 1102 may store information such as user profile information, contract orders, configuration information, or administration information from the devices and modules 1110 in a data storage 1112 device or cloud database service.

As an example, a user may enter into a smart contract via the RTSC computing device 1114, may be verified by the user eligibility module 1116, may estimate the amount of cryptocurrency gas required for a smart contract order using the gas estimation module 1118, and may enter order parameters to automatically generate smart orders via the order generation module 1120. The user may also engage in market order splitting and receiving rewards for providing risk coverage via the RTSC computing device 1114.

In some embodiments, conventional insurance carriers with a desire to offer their clients coverage against space weather related loss may utilize the space weather risk marketplace platform to enter into and manage space weather risk transfer financial instruments. By utilizing the marketplace platform, conventional insurance carriers have access to a new source of risk capacity for policy coverage, namely the distributed, accredited, and crowd-sourced risk coverage provided by risk parties in risk transfer smart contracts (RTSC) on the platform.

As a non-limiting example, an insurance carrier acting as a hedge party may enter into a RTSC with a risk party or risk parties for a specific set of space weather related conditions. The risk coverage defined in the RTSC may partially or fully underwrite insurance carrier policies offered to their clients covering them against that specific set of space weather related conditions. By entering into RTSCs as a hedge party, conventional insurance carriers directly enter into financial instruments that fund their ability to offer insurance policies to their clients without their clients' direct use or need to trust the marketplace platform and its processes, or a need for their clients to have direct involvement with blockchain networks, smart contracts, crypto currencies and the processes involved with such technologies. In some embodiments, a conventional insurance carrier may use the platform directly or may use an application programming interface (API) to access certain marketplace platform functionality without having to use the platform directly.

In some embodiments, a conventional insurance carrier may offer clients parametric insurance policies that offer coverage for space weather conditions by utilizing marketplace platform risk transfer smart contracts to effectively underwrite a policy offered to a client. A conventional insurance carrier may enter into RTSCs as the hedge party seeking risk coverage, which serves as the risk capacity of an insurance policy they offer their client. Conventional insurance carriers may charge their clients the cost of the hedge premium, plus a service fee that covers their operational or other overhead costs associated with RTSC administration and management. Conventional insurance carriers would pass on RTSC settlements to their clients should the payout conditions of the RTSC be met during the duration of the contract. In this sense, conventional insurance carriers may be thought of acting as authorized agents of their clients by entering into RTSCs on their behalf and for handling the interactions with the disclosed marketplace platform.

In some embodiments, a conventional insurance carrier may use the marketplace platform on behalf of a client who wishes to hedge against space weather risk but who may be averse to using blockchain technology directly. The conventional insurance carrier may also do so for the convenience of a client by integrating space weather risk coverage into an existing insurance solution, thereby creating a seamless experience for the client. In this role, the conventional insurance carrier provides a layer of abstraction for clients away from the blockchain technologies that power the risk capacity of the insurance policy's coverage, while providing clients the benefit of access to space weather risk management solutions.

In some embodiments, a conventional insurance carrier may offer a client space weather risk coverage as an addition to the client's existing insurance policy or as a standalone insurance product. Conventional insurance carriers may secure external capacity to underwrite such insurance products for their clients by entering into marketplace platform risk transfer smart contracts (RTSC) where they act as hedge parties. This allows them to gain access to the available risk capacity of the distributed, accredited, and crowd sourced risk parties on the marketplace platform. The amount of risk capacity an insurance carrier gains access to and the types of risk it will be able to cover for clients is dependent on the risk coverage and the parameters of the RTSCs.

As mentioned, conventional insurance carriers may provide an insurance product that is subject to a claims process requirement for a customer who experiences a loss. Such carriers may use their own parametric risk coverage secured in an RTSC as the underlying basis for offering a conventional form of insurance policy by determining the likelihood of damage based on the strength space weather conditions through historical data, modeling, and/or other analytical means.

In this scenario, the insurance carrier customers benefit from receiving a conventional insurance policy that covers space weather risk while the carrier benefits from being able to use their market knowledge to craft a hedge position that covers the likelihood of an actual incurred loss by their customers. In some embodiments, an insurance carrier entering into their own private RTSC on the marketplace platform as the hedge party may receive a payout settlement if space weather conditions were met during the contract period, though their customer may not have experienced a loss and therefore will not be entitled to the claims process or payment.

In some embodiments, a conventional insurance carrier may submit a hedge order on the marketplace platform with the specific parameters they are seeking to cover in policies offered to their clients. The risk transfer smart contract (RTSC) computing device may identify hedge orders and risk orders with complimentary parameters and then match the orders to generate smart contracts that are written to a distributed ledger. For each RTSC, the RTSC computing device may poll the blockchain Oracle to determine if the space weather index value threshold was met and if so, thereby trigger the payout condition and RTSC settlement, where this automatically disburses the digital currency defined in the risk coverage to the hedge party. In this way, a conventional insurance carrier has the ability to enter into an RTSC as the hedge party on behalf of a customer or to create a hedge position to cover actual losses from space weather conditions.

In some embodiments, a conventional insurance carrier may enter into their own marketplace platform risk transfer smart contract (RTSC) as a way to secure the underwriting risk capacity to cover conventional insurance policy liabilities offered to their customers. Once sufficient RTSC capacity has been secured in the form of RTSC risk coverage, a carrier will have sufficient risk capacity to cover space weather related customer insurance policies. A carrier may enter into the RTSC as a hedge party and utilize customer insurance premiums to pay for the RTSC hedge premium. Any parametric payout a carrier receives as a result of space weather conditions being met covers the customer insurance policy liability.

A benefit for a conventional insurance carrier is that they can leverage their expertise in insurance underwriting to determine acceptable levels of risk to undertake in customer policies, where that level of risk does not exceed the amount of risk capacity available from carrier held RTSCs. This is a valuable expertise that may include the analysis of historical data of space weather conditions, modeling, and other analytical means a carrier's underwriting team or process has at its disposal. Conventional insurance carriers, especially ones with experience in space insurance and insuring electrical grids, may have an asymmetrical information advantage over others of the community of risk parties participating on the marketplace platform, and that may allow them to more accurately assess space weather risk and the likelihood of damage resulting from specified space weather conditions.

Customers of conventional insurance policies seeking insurance claim payments are required to show proof of policy covered asset damage as a result of space weather conditions to initiate an insurance claims process. In the event a policy holder is unable to show proof of damage from space weather conditions as defined in their insurance policy, conventional insurance carriers may be able to fully retain the parametric payout they receive from an RTSC since no claim is paid to the policy holder. In situations where the policy holder is able to show proof of partial damage from space weather conditions and a claim is paid, but where the claim paid to the policy holder is less than the full amount of the parametric payout settlement received by the insurance carrier via their RTSC, the insurance carrier profits by retaining the difference between the payout received and the claim paid.

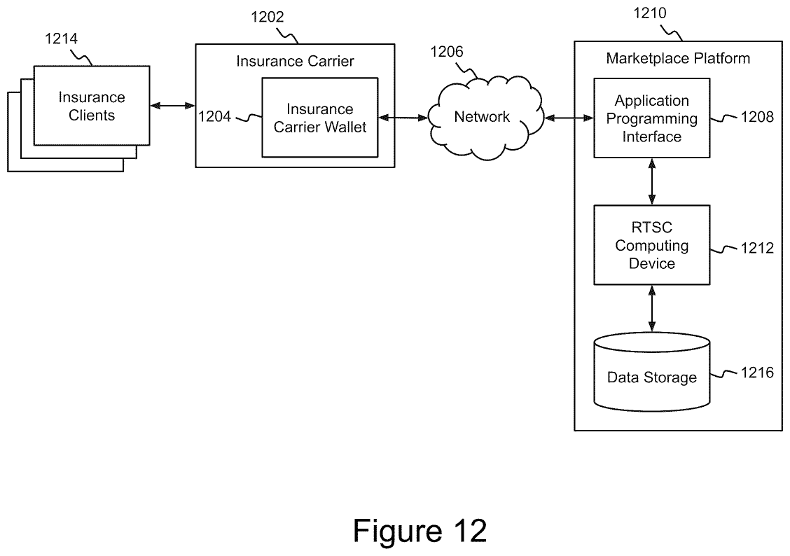

FIG. 12 illustrates a system and method for a conventional insurance carrier to participate in space weather risk transfer wherein an insurance carrier 1202 connects their insurance carrier wallet 1204 over a network connection (such as the Internet) 1206 via an application programming interface (API) 1208 to the marketplace platform 1210 for the purpose of connecting to the risk transfer smart contract (RTSC) computing device 1212 to enable entering into an RTSC. In such an arrangement, the insurance carrier 1202 is able to offer an insurance customer/client 1214 a parametric space weather risk policy and/or space weather risk coverage in the form of a conventional insurance policy which is subject to a claims process. In some embodiments, insurance carrier 1202 may enter into their own private RTSC on the marketplace platform 1210 as the hedge party and may receive a payout settlement if space weather conditions were met during the contract period, though their conventional insurance customer/client 1214 may not have experienced a loss and therefore will not be entitled to the claims process or payment. Platform 1210 may store information such as user profile information, contract orders, configuration information, or administration information in a data storage 1216 device or cloud database service.

In some embodiments, conventional insurance carriers may be able to provide conventional insurance coverage or parametric insurance policies to customers/clients so the customers/clients may hedge against elevated space weather conditions. To provide this service, a conventional insurance carrier may enter into risk transfer smart contracts (RTSC) as the hedge party to secure the necessary underlying risk capacity for offering space weather risk coverage to their customers/clients. The amount of risk capacity an insurance carrier gains, and the types of risk they will be able to cover in customer/client policies is dependent on the risk coverage and the parameters of the RTSC(s) they enter into.

In this arrangement, the disclosed marketplace for space weather risk transfer provides the risk capacity for offering insurance policies in lieu of using a claims reserve, which are funds set aside for future payment of incurred claims that have not yet been settled. The insurance carrier's active RTSC(s) risk coverage may act as a supplementary insurance claims reserve by providing guaranteed automatic parametric payouts to the carrier should the payout conditions be met, and in this way to cover future customer/client claims. In this sense, a sophisticated insurance carrier should be able to manage the risk of future claims by creating a de facto insurance reserve using RTSC(s).

In some embodiments, a conventional insurance carrier may use a risk transfer smart contract (RTSC) to create a virtual insurance reserve to cover the potential for future claims from space weather conditions in insurance policies they issue. By utilizing RTSCs on the space weather risk marketplace acting as hedge users, conventional insurance carriers may hedge against potential claims payout obligations for client policies due to isolated environmental conditions or events. The insurance reserve derived from the space weather risk marketplace may also allow a conventional insurance carrier to offer new policies and expand coverage for their customers/clients that was not possible prior to existence of the space weather risk market and the additional risk capacity it provides. As a result, a conventional insurance carrier may gain new capacities to expand their business by entering into the space weather risk market and creating new insurance policies without the need for expanding their insurance reserves.

As mentioned, the conventionally available space insurance market is limited with regards to which clients are covered, which assets are covered, and when such assets or clients are eligible for coverage. When it does provide coverage for an asset, the conventional space insurance market may cover a bundle of risks associated with satellites including, but not limited to, loss of equipment due to space weather, liability for damage to third parties during launch, partial or total loss of satellite functionality due to equipment failure, loss from in orbit collisions, and loss from a shortened lifetime of the satellite, as non-limiting examples. Because a bundle of risks is covered by conventional space insurance, the risk to the carrier is greater than if the policy only covered a single isolated risk. The greater risk to carrier oftentimes results in coverage denials, coverage limits or high insurance premiums.

The space weather risk transfer method and systems disclosed and/or described herein isolate the risk of space weather conditions from the multitude of risks covered by insurance carriers and enable targeted coverage previously unavailable to asset owners seeking coverage. The disclosed risk transfer smart contracts (RTSC) rely on space weather index data from trusted third parties, including but not limited to Kp Index, 10.7 cm Index, and/or Dst Index to create and settle smart contracts used to transfer risk from the hedge party to the risk party. The risk party (which effectively underwrites the risk associated with the RTSC defined space weather conditions) receives a payment in the form of the hedge premium, whereas the hedge party receives the RTSC defined risk coverage if the RTSC defined payout conditions are met during the contract duration.

The disclosed space weather risk transfer market isolates and transfers only the risk from space weather conditions, and in doing so isolates the risk of providing coverage, reduces the cost of coverage and may close the gap of unserved or underserved asset owners vulnerable to space weather conditions. The space weather risk transfer method and systems disclosed and/or described herein fulfills a need for coverage in the industry, as such a market (or at least an effective and practical one) does not presently exist.

The use of the disclosed space weather risk transfer market by a traditional insurance company may provide a conventional insurance carrier the ability to offer both conventional insurance policies and parametric insurance policies using parametric payout risk transfer smart contracts. Conventional insurance carriers may therefore gain access to new risk capacities to augment their current risk capacities, thereby helping them underwrite additional coverage options for space weather related risks.

This is accomplished in part by leveraging the disclosed space weather risk marketplace of distributed, accredited and crowd sourced risk parties without the need to add conventional insurance reserves. Conventional insurance carriers, especially ones with experience in space insurance and insuring electrical grids, may have an asymmetrical information and/or risk assessment advantage over others in the community of risk parties participating on the marketplace platform. This may enable them to more accurately assess space weather risk and the likelihood of damage from space weather conditions. Because the disclosed space weather risk transfer market is a market that isolates and transfers only the risk from space weather conditions, this solution allows insurance carriers to simplify and lower the cost of their claims settlement processes when offering isolated coverage of space weather conditions to their clients.

The marketplace model disclosed and/or described herein provides one or more of the following innovations and benefits in the field of risk transfer. It allows parties anonymous to each other to directly engage in self-administered risk transfer smart contracts (RTSCs) with each other for the purposes of covering tangible assets or businesses against the effects of environmental conditions or events. Blockchain enables the necessary anonymity for parties to enter into RTSCs in a trustless and frictionless manner since there is no longer a need for a central authority to screen users and assets that might result in denied coverage, limited coverage, and/or high coverage costs.

The proposed solution is unique as an offering and there are multiple reasons why other businesses may find it undesirable to modify their offerings to offer a similar solution. For example, the disclosed marketplace participation is validated when users pass jurisdictionally required KYC, AML and accreditation checks but their identities are hidden from other marketplace users, thereby allowing all validated users equal access to unbiased contract engagement. The solution is not provided as insurance by the marketplace provider as the solution's risk transfer smart contracts rely on the transparency of the blockchain structure and the decentralization of self-directed users, and its operation does not require trust in a centralized authority to hold their currency or underwrite contracts.

It is not an exchange in the sense a stock exchange or digital asset exchange works since the proposed marketplace does not offer a mechanism for the trading of fiat dollars for stock, or dollars for tokens, or tokens for tokens, making such exchanges poor comparisons to the disclosed solution. The solution proposed is non-custodial by design, allowing users to connect private wallets to the marketplace to conduct smart contract operations. This would mean that other marketplaces that are custodial would have to change their account balance model to a non-custodial cryptocurrency wallet model, something that centralized marketplaces may find undesirable as giving users that option could diminish the ability of the centralized authority to leverage unused client fiat funds in accounts as per current practices, and diminish the ability to gain insight into their future business pipeline, thereby resulting in difficulty scaling their services.

In addition, by implementing blockchain technology into a centralized fiat currency-based exchange or options contract provider, the centralized provider is faced with the difficulty in properly supporting services that are partially or mostly decentralized. This is because decentralized features generally come with no centralized support, which could lead to unsatisfied customers, thus making the adaptation a risky proposition if user retention and consistency of customer experience for their current business is a high priority.

Embodiments enable a decentralized community of risk parties to act as a virtually unlimited supply of risk capacity (supply) for the hedge parties seeking coverage (demand). The decentralized community of risk parties helps to remove conventional underwriting coverage limits dictated by a central authority, thereby eliminating coverage gaps that exist currently within markets. This decentralized nature of risk capacity available for risk transfer smart contracts allows the marketplace provider to supply the underlying infrastructure for risk transfer without acting as an underwriter or provider of insurance.

The marketplace offers risk parties dashboards assisting in the analysis and management of their individual risk exposure. The marketplace market order splitting (MOS) feature splits larger orders into smaller ones enabling partial coverage when no coverage would have been possible otherwise. By isolating environmental risks, marketplace enabled RTSCs cost hedge parties less than bundled policies offered by conventional carriers would. The marketplace allows its market participants to determine their risk transfer smart contract terms through a publicly available bid/ask order book.

The marketplace further automates contract creation by matching compatible orders rapidly giving users unmatched speed in procuring coverage when near term environmental forecasts threaten assets or business operations bypassing delays otherwise imposed by conventional carriers during times of impending environmental activity. The marketplace may also tokenize each market to incentivize participation with token rewards helping establish long-term participants for each risk market. The marketplace works with any environmental risk market that is measurable.

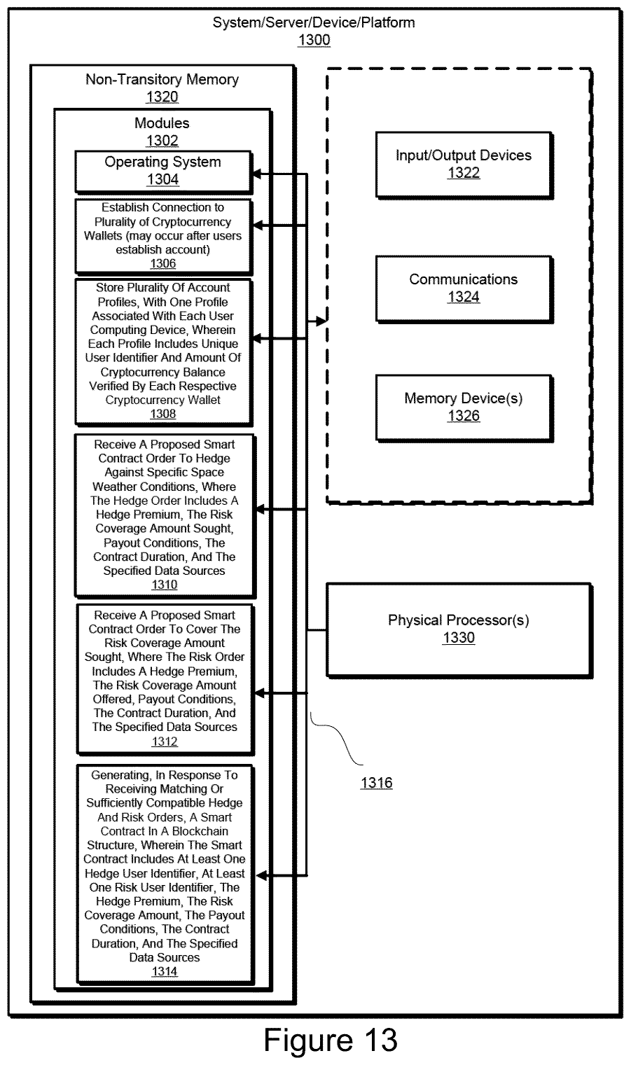

FIG. 13 is a diagram illustrating elements or components that may be present in a computer device or system configured to implement a method, process, function, or operation in accordance with an embodiment of the system and methods disclosed herein. As noted, in some embodiments, the system and methods may be implemented in the form of an apparatus that includes a processing element and set of executable instructions. The executable instructions may be part of a software application and arranged into a software architecture.

In general, an embodiment may be implemented using a set of software instructions that are designed to be executed by a suitably programmed processing element (such as a GPU, CPU, TPU, QPU, microprocessor, processor, co-processor, or controller, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed systems, apparatuses, and methods.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

The modules may contain one or more sets of instructions for performing a method or function described with reference to the Figures, and the descriptions of the functions and operations provided in the specification and Appendix. These modules may include those illustrated but may also include a greater number or fewer number than those illustrated. As mentioned, each module may contain a set of computer-executable instructions. The set of instructions may be executed by a programmed processor contained in a server, client device, network element, system, platform, or other component.

A module may contain instructions that are executed by a processor contained in more than one of a server, client device, network element, system, platform, or other component. Thus, in some embodiments, a plurality of electronic processors, with each being part of a separate device, server, or system may be responsible for executing all or a portion of the software instructions contained in an illustrated module. Thus, although FIG. 13 illustrates a set of modules which taken together perform multiple functions or operations, these functions or operations may be performed by different devices or system elements, with certain of the modules (or instructions contained in those modules) being associated with those devices or system elements.

As shown in FIG. 13, system 1300 may represent a server or other form of computing or data processing system, platform, or device. Modules 1302 each contain a set of executable instructions, where when the set of instructions is executed by a suitable electronic processor or processors (such as that indicated in the figure by “Physical Processor(s) 1330”), system (or server, platform, or device) 1300 operates to perform a specific process, operation, function, or method.

Modules 1302 are stored in a (non-transitory) memory 1320, which typically includes an Operating System module 1304 that contains instructions used (among other functions) to access and control the execution of the instructions contained in other modules. The modules 1302 stored in memory 1320 are accessed for purposes of transferring data and executing instructions by use of a “bus” or communications line 1316, which also serves to permit processor(s) 1330 to communicate with the modules for purposes of accessing and executing a set of instructions. Bus or communications line 1316 also permits processor(s) 1330 to interact with other elements of system 1300, such as input or output devices 1322, communications elements 1324 for exchanging data and information with devices external to system 1300, and additional memory devices 1326.

For example, Modules 1302 may contain computer-executable instructions which when executed by a programmed processor cause the processor or a device in which it is implemented to perform the following process, method, function, or operation:
enabling a platform, apparatus, or server to establish a connection to a plurality of cryptocurrency wallets, with each wallet associated with one of a plurality of user computer devices (as suggested by module 1306);
   note that this may occur after an interested user connects to and establishes an account with the marketplace RTSC computing device (typically a server that forms part of a platform or system);
storing a plurality of account profiles, with one such profile associated with each computing device of the plurality of user computing devices, wherein each profile includes a unique user identifier, and the amount of cryptocurrency balances verified by each respective cryptocurrency wallet (as suggested by module 1308);
receiving at the platform, apparatus, or server (referred to as a RTSC device herein), via one or more associated network interfaces, from at least one user computer device of the plurality of the user computer devices, a proposed smart contract order to hedge against specific space weather conditions (“hedge order”), wherein the hedge order includes a hedge premium, the risk coverage amount sought, payout conditions, the contract duration, the specified data sources, and in some cases, other available smart contract user parameter(s) or option(s) (as suggested by module 1310);
receiving at the RTSC device, via one or more associated network interfaces, from at least one user computing device of the plurality of the user computer devices, a proposed smart contract order to cover the risk coverage amount sought (“risk order”), wherein the risk order includes a hedge premium, the risk coverage amount offered, payout conditions, the contract duration, the specified data sources, and in some cases other available smart contract user parameter(s) or option(s) (as suggested by module 1312);
generating, in response to receiving matching (or otherwise sufficiently compatible) orders for both the hedge order and the risk order, a smart contract in a blockchain structure, wherein the smart contract includes at least one hedge user identifier, at least one risk user identifier, the hedge premium, the risk coverage amount, the payout conditions, the contract duration, the specified data sources, and if relevant other available smart contract user parameter(s) or option(s) selected by the hedge user and/or risk user (as suggested by module 1314).

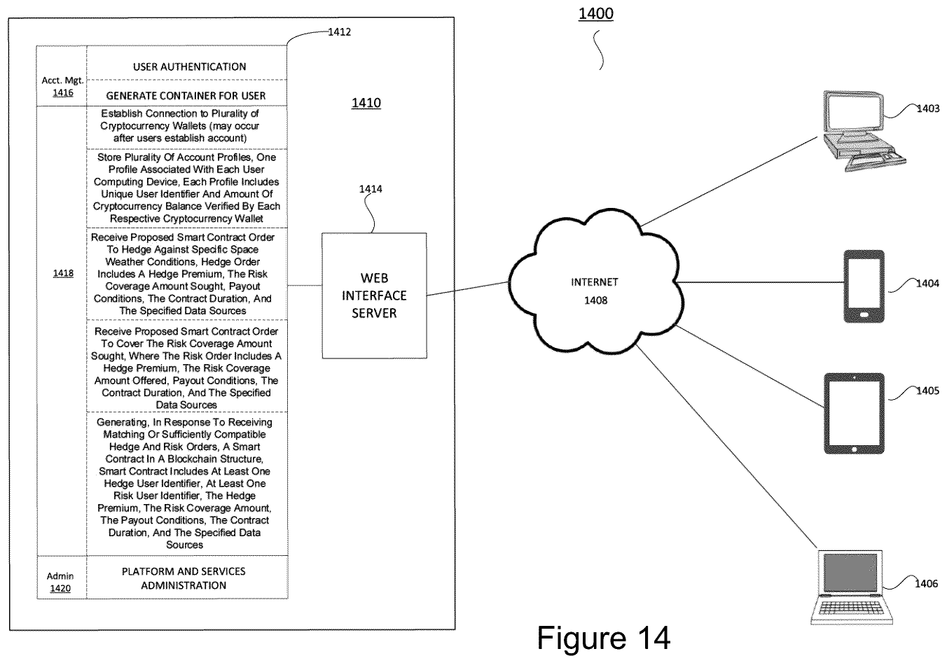

In some embodiments, the systems and methods disclosed and/or described herein may provide services through a SaaS or multi-tenant platform. In such an embodiment, the Saas platform may operate or function as an element of the disclosed marketplace. The platform provides access to multiple entities, each with a separate account and associated data storage. Each account may correspond to a hedge user, a risk user, or other entity utilizing the platform, a set or category of entities, a set or category of users, a set or category risks caused by space-related weather events, a set or category of objects or services impacted by space weather or other environmental events, an industry, or an organization, as non-limiting examples. Each account may access one or more services, a set of which are instantiated in their account, and which implement one or more of the methods or functions described herein. FIGS. 14-16 are diagrams illustrating an architecture for a multi-tenant or SaaS platform that may be used in implementing an embodiment of the systems and methods disclosed herein.

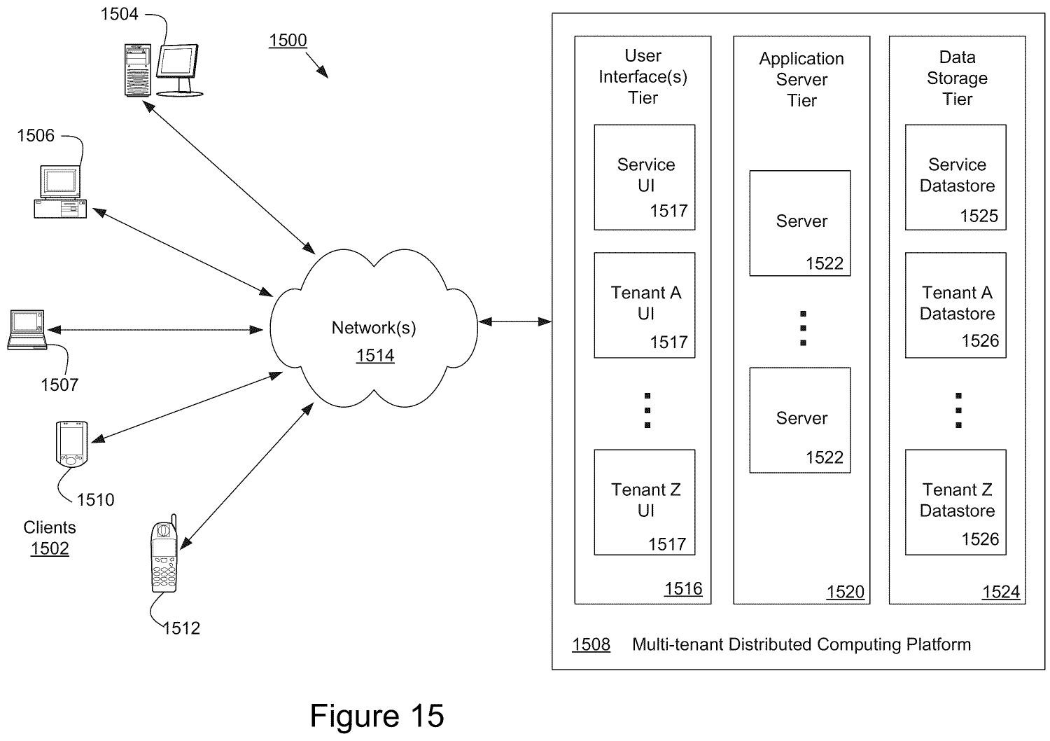

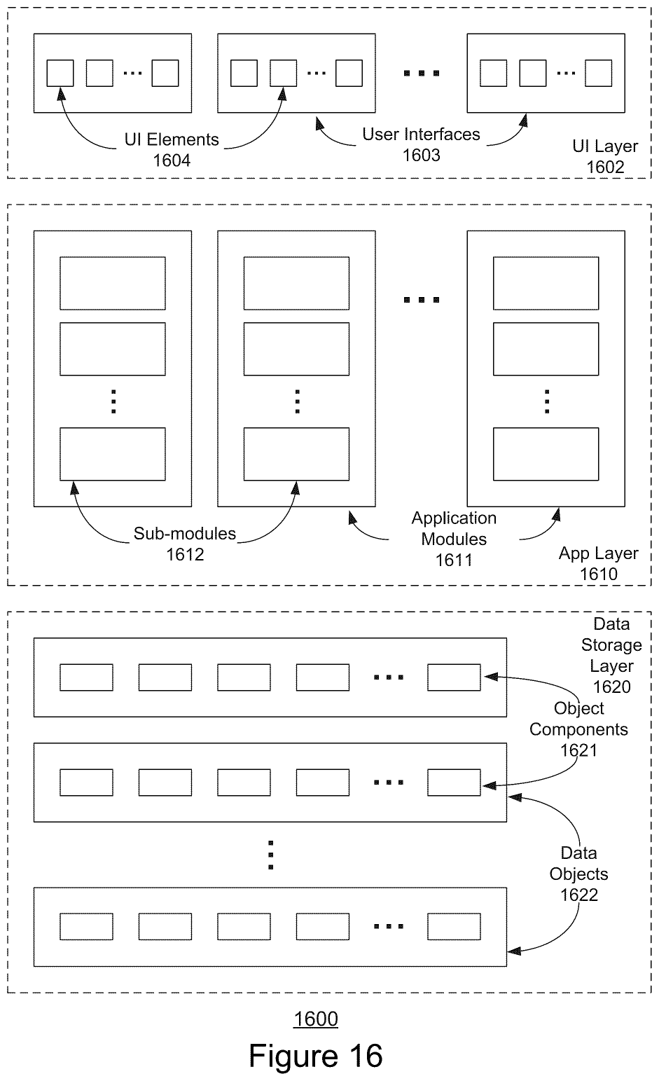

FIG. 14 is a diagram illustrating a SaaS system in which an embodiment of the disclosure may be implemented. FIG. 15 is a diagram illustrating elements or components of an example operating environment in which an embodiment of the disclosure may be implemented. FIG. 16 is a diagram illustrating additional details of the elements or components of the multi-tenant distributed computing service platform of FIG. 15, in which an embodiment of the disclosure may be implemented.

In some embodiments, the system or service(s) disclosed and/or described herein may be implemented as micro-services, processes, workflows, or functions performed in response to requests. The micro-services, processes, workflows, or functions may be performed by a server, data processing element, platform, or system. In some embodiments, the services may be provided by a service platform located “in the cloud”. In such embodiments, the platform is accessible through APIs and SDKs.

The described document processing and evaluation services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 14-16 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the marketplace processes disclosed and/or described herein.

Although in some embodiments, a platform or system of the type illustrated in FIGS. 14-16 may be operated by a 3rd party provider, in other embodiments, the platform may be operated by a provider and a different source may provide the applications or services for users through the platform.

FIG. 14 is a diagram illustrating a system 1400 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, stores, or organizations, as non-limiting examples. A user may access the services using a suitable client, including but not limited to desktop computers, laptop computers, tablet computers, scanners, or smartphones. In general, a client device having access to the Internet may be used to provide a request or text message requesting a service (such as the processing of a document). Users interface with the service platform across the Internet 1408 or another suitable communications network or combination of networks. Non-limiting examples of suitable client devices include desktop computers 1403, smartphones 1404, tablet computers 1405, or laptop computers 1406.

System 1410, which may be hosted by a third party, may include a set of services 1412 and a web interface server 1414, coupled as shown in FIG. 14. It is to be appreciated that either or both of services 1412 and the web interface server 1414 may be implemented on one or more different hardware systems and components, even though represented as singular units in FIG. 14. Services 1412 may include one or more functions or operations for the operation and functioning of the risk transfer platform and processes disclosed and/or described herein.

In some embodiments, the set of applications or services available to a user may include one or more that perform the functions and methods disclosed and/or described herein. As examples, in some embodiments, the set of applications, functions, operations or services made available through the platform or system 1410 may include:
account management services 1416, such as
   a process or service to authenticate a person or entity requesting data processing and/or asset protection services (such as credentials, proof of purchase, or verification that the customer has been authorized by a company to use the services provided by the platform);
   a process or service to receive a request for participating in the asset protection marketplace disclosed and/or described herein;
   an optional process or service to generate a price for the requested service or a charge against a service contract;
   a process or service to generate a container or instantiation of the requested processes for a user/customer, where the instantiation may be customized for a particular company; and
   other forms of account management services;
a set of processes or services 1418, such as
   enabling a platform, apparatus, or server to establish a connection to a plurality of cryptocurrency wallets, with each wallet associated with one of a plurality of user computer devices;
      note that this may occur after an interested user connects to and establishes an account with the marketplace RTSC computing device (typically a server that forms part of a platform or system);
   storing a plurality of account profiles, with one such profile associated with each computing device of the plurality of user computing devices, wherein each profile includes a unique user identifier, and the amount of cryptocurrency balances verified by each respective cryptocurrency wallet;
   receiving at the platform, apparatus, or server (referred to as a RTSC device herein), via one or more associated network interfaces, from at least one user computer device of the plurality of the user computer devices, a proposed smart contract order to hedge against specific space weather conditions (“hedge order”), wherein the hedge order includes a hedge premium, the risk coverage amount sought, payout conditions, the contract duration, the specified data sources, and in some cases, other available smart contract user parameter(s) or option(s);
   receiving at the RTSC device, via one or more associated network interfaces, from at least one user computing device of the plurality of the user computer devices, a proposed smart contract order to cover the risk coverage amount sought (“risk order”), wherein the risk order includes a hedge premium, the risk coverage amount offered, payout conditions, the contract duration, the specified data sources, and in some cases other available smart contract user parameter(s) or option(s);
   generating, in response to receiving matching (or otherwise sufficiently compatible) orders for both the hedge order and the risk order, a smart contract in a blockchain structure, wherein the smart contract includes at least one hedge user identifier, at least one risk user identifier, the hedge premium, the risk coverage amount, the payout conditions, the contract duration, the specified data sources, and if relevant other available smart contract user parameter(s) or option(s) selected by the hedge user and/or risk user;
administrative services 1420, such as
   a process or services to enable the provider of the data processing and services and/or the platform to administer and configure the processes and services provided to users.

The platform or system shown in FIG. 14 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server (as examples). A web server is a most often a combination of hardware and the software that helps deliver content, commonly by hosting a website, to client web browsers that access the web server via the Internet.

FIG. 15 is a diagram illustrating elements or components of an example operating environment 1500 in which an embodiment of the disclosure may be implemented. As shown, a variety of clients 1502 incorporating and/or incorporated into a variety of computing devices may communicate with a multi-tenant service platform 1508 through one or more networks 1514. For example, a client may incorporate and/or be incorporated into a client application (e.g., software) implemented or executed at least in part by one or more of the computing devices. Examples of suitable computing devices include personal computers, server computers 1504, desktop computers 1506, laptop computers 1507, notebook computers, tablet computers or personal digital assistants (PDAs) 1510, smart phones 1512, cell phones, and consumer electronic devices incorporating one or more computing device components (such as one or more electronic processors, microprocessors, central processing units (CPU), or controllers). Examples of suitable networks 1514 include networks utilizing wired and/or wireless communication technologies and networks operating in accordance with any suitable networking and/or communication protocol (e.g., the Internet).

The distributed computing service/platform (which may also be referred to as a multi-tenant data processing platform) 1508 may include multiple processing tiers, including a user interface tier 1516, an application server tier 1520, and a data storage tier 1524. The user interface tier 1516 may maintain multiple user interfaces 1517, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations, as non-limiting examples. Each application server or processing tier 1522 shown in the figure may be implemented with a set of computers and/or components including computer servers and processors, and may perform various functions, methods, processes, or operations as determined by the execution of a software application or set of instructions. The data storage tier 1524 may include one or more data stores, which may include a Service Data store 1525 and one or more Tenant Data stores 1526. Data stores may be implemented with a suitable data storage technology, including structured query language (SQL) based relational database management systems (RDBMS).

Service Platform 1508 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 1522 that are part of the platform's Application Server Tier 1520. As noted with regards to FIG. 14, the platform system shown in FIG. 15 may be hosted on a distributed computing system made up of at least one, but typically multiple, “servers.”

As mentioned, rather than build and maintain such a platform or system themselves, a business may utilize a platform or system provided by a third party. A third party may implement a business system/platform as described in the context of a multi-tenant platform, where individual instantiations of a business' data processing workflow (such as the marketplace for asset protection disclosed and/or described herein) are provided to users, with each company/business representing a tenant of the platform. One advantage to such multi-tenant platforms is the ability for each tenant to customize their instantiation of the data processing workflow to that tenant's specific business needs or operational methods. Further, each tenant may be a business or entity that uses the multi-tenant platform to provide business services and functionality to multiple users.

FIG. 16 is a diagram illustrating additional details of the elements or components of the multi-tenant distributed computing service platform of FIG. 15, in which an embodiment of the disclosure may be implemented. In general, an embodiment may be implemented using a set of software instructions that are designed to be executed by a suitably programmed processing element (such as a CPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational platform.

The example architecture 1600 of a multi-tenant distributed computing service platform illustrated in FIG. 16 includes a user interface layer or tier 1602 having one or more user interfaces 1603. Examples of such user interfaces include graphical user interfaces and application programming interfaces (APIs). Each user interface may include one or more interface elements 1604. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 1610 may include one or more application modules 1611, each having one or more associated sub-modules 1612. Each application module 1611 or sub-module 1612 may correspond to a function, method, process, or operation that is implemented by the module or sub-module (e.g., a function or process related to providing data processing and other services to a user of the platform). Such function, method, process, or operation may include those used to implement one or more aspects of the disclosed system and methods, such as for one or more of the processes or functions disclosed and/or described with reference to the specification and Figures:
enabling a platform, apparatus, or server to establish a connection to a plurality of cryptocurrency wallets, with each wallet associated with one of a plurality of user computer devices;
   note that this may occur after an interested user connects to and establishes an account with the marketplace RTSC computing device (typically a server that forms part of a platform or system);
storing a plurality of account profiles, with one such profile associated with each computing device of the plurality of user computing devices, wherein each profile includes a unique user identifier, and the amount of cryptocurrency balances verified by each respective cryptocurrency wallet;
receiving at the platform, apparatus, or server (referred to as a RTSC device herein), via one or more associated network interfaces, from at least one user computer device of the plurality of the user computer devices, a proposed smart contract order to hedge against specific space weather conditions (“hedge order”), wherein the hedge order includes a hedge premium, the risk coverage amount sought, payout conditions, the contract duration, the specified data sources, and in some cases, other available smart contract user parameter(s) or option(s);
receiving at the RTSC device, via one or more associated network interfaces, from at least one user computing device of the plurality of the user computer devices, a proposed smart contract order to cover the risk coverage amount sought (“risk order”), wherein the risk order includes a hedge premium, the risk coverage amount offered, payout conditions, the contract duration, the specified data sources, and in some cases other available smart contract user parameter(s) or option(s);
generating, in response to receiving matching (or otherwise sufficiently compatible) orders for both the hedge order and the risk order, a smart contract in a blockchain structure, wherein the smart contract includes at least one hedge user identifier, at least one risk user identifier, the hedge premium, the risk coverage amount, the payout conditions, the contract duration, the specified data sources, and if relevant other available smart contract user parameter(s) or option(s) selected by the hedge user and/or risk user.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 1522 of FIG. 15) may include each application module. Alternatively, different application servers may include different sets of application modules. Such sets may be disjoint or overlapping.

The data storage layer 1620 may include one or more data objects 1622 each having one or more data object components 1621, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 14-16 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review (as non-limiting examples).

Embodiments of the disclosure are directed to various aspects of establishing and operating a marketplace for transfer of risks associated with space weather events. These embodiments include at least the following:
Embodiment of marketplace for risk markets

In some embodiments, a parametric risk transfer marketplace platform is provided, where users may create, enter and manage risk transfer financial instruments in a fast and efficient manner. The marketplace platform may allow for the transfers of risks based on measurements such as (but not limited to, or required to include) space weather conditions, solar radiation, precipitation, seismic measurements, wind speed and direction, air temperature, air quality, and wave heights.

The marketplace platform may provide contract relevant data and allow users to enter into risk transfer smart contracts (RTSC) by either creating or accepting risk transfer orders. The RTSC computing device (typically a server or other form of processor) is integrated into the marketplace platform and performs the requisite functions.

In some embodiments, the marketplace platform may be cloud based and comprise at least one server with at least one database. The cloud database may further include one or more well-known databases (such as a SQL database) or a fixed content storage system to store content, user profile information, contract orders, configuration information or administration information as necessary to execute the cloud services.

In some embodiments, one or more networks providing computing infrastructure on behalf of one or more users may be referred to as a cloud, and resources may include, without limitation, data center resources, applications (e.g., software-as-a-service or platform-as-a-service) and management tools. In this way, in accordance with various embodiments, the users may control, initiate, and engage in self-directed risk transfer smart contracts efficiently without a required understanding of the underlying hardware and software necessary to interface, communicate, manipulate, and exchange information and/or data necessary to deliver such services.

In some embodiments, the risk transfer marketplace platform has global reach via internet connectivity and allows a global market of hedge and risk parties deemed eligible for RTSC participation by the marketplace platform's customer due diligence (CDD) process to participate in RTSCs. The nature of the marketplace platform is to allow hedge parties to gain access to a distributed, crowd source of accredited risk parties that in aggregate act as a virtual risk pool for the areas of risk addressed by the marketplace.
Embodiment of identifying new risk markets

In some embodiments, a project/platform administrator may identify new risk categories or markets that are suitable for inclusion in the available risk transfer financial instrument offerings.

As a non-limiting example, in one embodiment, the administrator may determine that precipitation amounts may be a suitable parametric risk transfer smart contract financial instrument that can be made available on the marketplace platform. The amount of precipitation may impact potential hedge parties in a number of ways including but not limited to excessive precipitation that could lead to flooding, or a lack of precipitation that could lead to crop failure. Each of these specific risks would be addressable as a way to provide risk coverage through the use of parametric or index-based risk transfer financial instruments that would allow the hedge party to pay a hedge premium to the risk party for risk coverage.
Embodiment for a programmatic polling for a new risk market, allowing users to vote on potential data sources and areas in need of additional risk capacity.

In some embodiments, the risk transfer marketplace platform may allow for holders of marketplace provided risk transfer smart contract specific cryptocurrency to provide input on identifying new risk markets they would like to have access to. This may be done by way of allowing a governance mechanism whereby the holders of approved marketplace risk transfer smart contract specific tokens may suggest and ultimately vote on a new risk market to be developed and offered. This may be considered a form or characteristic of a decentralized autonomous organization or DAO.

The amount of token each participant holds may give weight to their vote, whereby the token totals that vote for or against the new risk market are weighed toward whether the new risk market is created. The administrator may also identify the type of user-that is, whether they are a hedge party or a risk party-that votes in favor of a new risk market and use that information to determine if there is sufficient demand by each risk party for the particular new risk market.

The administrator may also identify previous risk transfer smart contract participation volume as a way to weigh votes from users. The hedge parties generally have to use less token in the form of hedge premiums in the RTSCs compared with the amount of token risk parties commit in the form of the risk coverage in the RTSCs. The administrator may weigh the relative matchup between the hedge and risk parties knowing the approximate amounts each party needs to provide in determining that there is sufficient balanced interest in the new risk market from both the hedge and risk parties. The holders of existing tokens from existing risk markets may determine if a new risk market and associated new token should be created.
Embodiment of identifying suitable parametric measures from trustworthy third party

In some embodiments, the administrator may identify a new risk category for potential inclusion in the available categories of risk transfer financial instruments and then may seek out the requisite parametric data sources and measures to create the risk transfer financial instruments. In one non-limiting example embodiment, a risk market for precipitation measures may have been identified and the administrator may then identify a suitable and trustworthy source of precipitation data and measures.

For example, within the US, the National Weather Service (NWS), which is a division of the National Oceanic and Atmospheric Administration (NOAA), has historical and near real-time data on precipitation measurements throughout the United States of America. The administrator may determine that this data is suitable for use in risk transfer smart contracts (RTSC) due to the information being in the public domain and freely available to use. The administrator may further identify the World Meteorological Service as a source of data for countries other than the USA.
Embodiment of creating a new blockchain for risk transfer smart contract

In some embodiments, the administrator may create a new blockchain structure for each new risk market. The risk transfer smart contracts for that risk market may have defined data sources that are used in the risk transfer smart contracts (RTSC) and therefore are unique to that risk market. The data sources embedded in the RTSCs are accessed by means of an Oracle. The RTSCs are associated with the risk category specific tokens that are created when the new blockchain structure is created.
Embodiment of using a market specific token as the currency for the risk coverage and hedge premium

In some embodiments, the digital currency used in the Risk Transfer Smart Contracts (RTSC) to provide the risk coverage and to pay the hedge premium may be a third-party digital currency such as Ethereum, or a stable coin such as USDC, which is pegged to the US dollar. In some embodiments, the digital currency used in the RTSC may be the native digital currency used for the blockchain network's native smart contracts such as using ETH tokens as the digital currency for a smart contract entered on the Ethereum Blockchain network.

In other embodiments the native digital currency used for the smart contracts hedge premium and risk coverage may be a third-party digital currency that is exclusive to the unique risk category Risk Transfer Smart Contract (RTSC) yet not exclusive to the Blockchain network it is entered onto, such as a yet unspecified or presently undisclosed ERC-20 based digital currency used in the RTSC which is entered onto the Ethereum or another Blockchain network. This embodiment has the advantage of making the RTSC and its exclusive risk category token purpose built for the task of mitigating the potential financial losses from the unique risk categories provided by the risk transfer marketplace platform utilizing well established and proven Blockchain networks.

Embodiments as disclosed and/or described herein can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

The disclosure includes the following clauses and embodiments:
1. A method for transferring risk associated with possible harm to an asset or disruption of a business arising from an environmental condition or event, comprising:
establishing a connection to a plurality of cryptocurrency wallets, wherein each wallet is associated with one of a plurality of user computing devices;
storing a plurality of account profiles, with one account profile associated with each computing device of the plurality of user computing devices, wherein each account profile includes a unique user identifier and a verified amount of cryptocurrency available from that user's respective cryptocurrency wallet;
receiving from at least one user computing device of the plurality of user computing devices, a hedge order to hedge against occurrence of a specific environmental condition of event, wherein the hedge order includes terms corresponding to a hedge premium offered, a risk coverage amount sought, a payout condition for the hedge order, a contract duration for the hedge order, and one or more data sources for use in determining whether the hedge order payout condition is satisfied;
receiving from at least one user computing device of the plurality of user computing devices, a risk order for a risk corresponding to occurrence of the specific environmental condition or event, wherein the risk order includes terms corresponding to a hedge premium sought, the risk coverage amount offered, a payout condition for the risk order, a contract duration for the risk order, and one or more data sources for use in determining whether the risk order payout condition is satisfied;
determining if the received hedge order and received risk order have acceptable values for the terms of the respective orders to proceed with establishing a smart contract between the received hedge order and received risk order;
generating a smart contract in a blockchain structure if the received hedge order and received risk order have acceptable values for the terms of the respective orders, wherein the smart contract includes at least one hedge user identifier, at least one risk user identifier, the hedge premium amount, the risk coverage amount, the payout condition or conditions, the contract duration, and the one or more of the data sources in the terms of the received hedge order and for the received risk order;
polling environmental data from one or more of the data sources in the smart contract;
determining based on the environmental data polled if the payout condition or conditions have been satisfied during the duration of the smart contract; and
disbursing the risk coverage amount to the hedge party if the payout condition or conditions have been met or disbursing the risk coverage amount to the risk party if the payout condition or conditions have not been met.
2. The method of clause 1, wherein the hedge order or risk order include one or more additional parameters or options, comprising:
a hedge premium payment to a party associated with the risk order if the payout condition or conditions are satisfied;
two or more payout conditions applicable to a single data source with a discrete hedge premium for each payout condition, wherein if one of the two or more payout conditions are satisfied, a payout is made to the user associated with the hedge order;
two or more data sources with a payout condition defined for each data source, whereas if one payout condition is satisfied, a payout is made to the user associated with the hedge order;
two or more data sources with a payout condition defined for each data source, whereas if all of the payout conditions are satisfied, a payout is made to the user associated with the hedge order;
a discount or price adjustment variable to override a default hedge premium cost calculation;
a contract service fee sharing percentage to be paid by the user associated with the hedge order and the user associated with the risk order; and
a desired number of blockchain Oracle checks over the duration of the smart contract to determine if a payout condition or conditions have been satisfied.
3. The method of clause 1, wherein the specific environmental condition or event is a risk category of space weather or a measurable event occurring in space.
4. The method of clause 3, wherein the data sources for the hedge order or for the risk order provide measurements of one or more of a Kp Index, a Dst Index, or a F10.7 Index.
5. The method of clause 1, wherein the specific environmental condition or event is a risk category of one or more of a hurricane, an earthquake, a flood level, a tropical storm, a level of precipitation or rainfall, a level of solar irradiance, a wildfire, a measured wind speed, a tornado measurement, a measure of air quality, a measured temperature, a wet bulb temperature, a tide water level, a measured wave height, an atmospheric gas measurement, a tsunami measurement, a volcanic eruption measurement, an algae bloom measurement, or a storm surge.
6. The method of clause 1, wherein the method is accessed through a platform or System, and further wherein a specific token is used as a currency for each unique risk category of environmental condition or event, the specific token being created by an administrator of the platform or system.
7. The method of clause 1, wherein the supply of risk coverage or risk capacity provided on the platform or system covering assets or businesses vulnerable to environmental conditions or events is decentralized across a community of discrete users associated with risk orders.
8. The method of clause 1, further comprising:
identifying at least one risk order that satisfies a portion of the risk coverage amount sought in a hedge order; and
splitting the hedge order into at least two smaller hedge orders, with at least one of the smaller hedge orders having a risk coverage amount that is equal to the risk coverage amount in the identified risk order.
9. The method of clause 1, further comprising enabling a conventional insurance carrier to access the platform marketplace for additional risk capacity.
10. The method of clause 1, wherein determining if the received hedge and risk orders have acceptable values for the terms of the respective orders to proceed with establishing a smart contract between the hedge order and risk order further comprises:

an exact match between the terms of the proposed hedge order and the proposed risk order; or

a match within a prescribed range of values for the terms of the hedge order and the risk order.
11. A system for transferring risk associated with possible harm to an asset or disruption of a business arising from an environmental condition or event, comprising:
one or more electronic processors configured to execute a set of computer-executable instructions; and
a non-transitory computer-readable medium including the set of computer-executable instructions, wherein when executed, the instructions cause the one or more electronic processors to
   establish a connection to a plurality of cryptocurrency wallets, wherein each wallet is associated with one of a plurality of user computing devices;
   store a plurality of account profiles, with one account profile associated with each computing device of the plurality of user computing devices, wherein each account profile includes a unique user identifier and a verified amount of cryptocurrency available from that user's respective cryptocurrency wallet;
   receive from at least one user computing device of the plurality of user computing devices, a hedge order to hedge against occurrence of a specific environmental condition or event, wherein the hedge order includes terms corresponding to a hedge premium offered, a risk coverage amount sought, a payout condition for the hedge order, a contract duration for the hedge order, and one or more data sources for use in determining whether the hedge order payout condition is satisfied;
   receive from at least one user computing device of the plurality of user computing devices, a risk order for a risk corresponding to occurrence of the specific environmental condition or event, wherein the risk order includes terms corresponding to a hedge premium sought, the risk coverage amount offered, a payout condition for the risk order, a contract duration for the risk order, and one or more data sources for use in determining whether the risk order payout condition is satisfied;
   determine if the received hedge order and received risk order have acceptable values for the terms of the respective orders to proceed with establishing a smart contract between the received hedge order and received risk order;
   generate a smart contract in a blockchain structure if the received hedge order and received risk order have acceptable values for the terms of the respective orders, wherein the smart contract includes at least one hedge user identifier, at least one risk user identifier, the hedge premium amount, the risk coverage amount, the payout condition or conditions, the contract duration, and the one or more of the data sources in the terms of the received hedge order and for the received risk order;
   poll environmental data from one or more of the data sources in the smart contract;
   determine based on the environmental data polled if the payout condition or conditions have been satisfied during the duration of the smart contract; and
   disburse the risk coverage amount to the hedge party if the payout condition or conditions have been met or disbursing the risk coverage amount to the risk party if the payout condition or conditions have not been met.
12. A non-transitory computer readable medium containing a set of computer-executable instructions that when executed by one or more programmed electronic processors, cause the processors to perform a process for risk transfer for possible harm to an asset or disruption of a business arising from an environmental condition or event by:
establishing a connection to a plurality of cryptocurrency wallets, wherein each wallet is associated with one of a plurality of user computing devices;
storing a plurality of account profiles, with one account profile associated with each computing device of the plurality of user computing devices, wherein each account profile includes a unique user identifier and a verified amount of cryptocurrency available from that user's respective cryptocurrency wallet;
receiving from at least one user computing device of the plurality of user computing devices, a hedge order to hedge against occurrence of a specific environmental condition or event, wherein the hedge order includes terms corresponding to a hedge premium offered, a risk coverage amount sought, a payout condition for the hedge order, a contract duration for the hedge order, and one or more data sources for use in determining whether the hedge order payout condition is satisfied;
receiving from at least one user computing device of the plurality of user computing devices, a risk order for a risk corresponding to occurrence of the specific environmental condition or event, wherein the risk order includes terms corresponding to a hedge premium sought, the risk coverage amount offered, a payout condition for the risk order, a contract duration for the risk order, and one or more data sources for use in determining whether the risk order payout condition is satisfied;
determining if the received hedge order and received risk order have acceptable values for the terms of the respective orders to proceed with establishing a smart contract between the received hedge order and received risk order;
generating a smart contract in a blockchain structure if the received hedge order and received risk order have acceptable values for the terms of the respective orders, wherein the smart contract includes at least one hedge user identifier, at least one risk user identifier, the hedge premium amount, the risk coverage amount, the payout condition or conditions, the contract duration, and the one or more of the data sources in the terms of the received hedge order and for the received risk order;
polling environmental data from one or more of the data sources in the smart contract;
determining based on the environmental data polled if the payout condition or conditions have been satisfied during the duration of the smart contract; and
disbursing the risk coverage amount to the hedge party if the payout condition or conditions have been met or disbursing the risk coverage amount to the risk party if the payout condition or conditions have not been met.

The software components, processes, or functions disclosed and/or described in this application may be implemented as software code to be executed by a processor using a suitable computer language such as Python, Java, JavaScript, C, C++, or Perl using conventional or object-oriented techniques. The software code may be stored as a series of instructions or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. Such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, synchronous dynamic random access memory (SDRAM), or similar devices or forms of memories based on similar technologies. Such computer-readable storage media allow the processing element or processor to access computer-executable process steps and application programs, stored on removable and non-removable memory media, to off-load data from a device or to upload data to a device. As mentioned, with regards to the embodiments disclosed and/or described herein, a non-transitory computer-readable medium may include a structure, technology, or method apart from a transitory waveform or similar medium.

Example embodiments of the disclosure are described herein with reference to block diagrams of systems, and/or flowcharts or flow diagrams of functions, operations, processes, or methods. One or more blocks of the block diagrams, or one or more stages or steps of the flowcharts or flow diagrams, and combinations of blocks in the block diagrams and combinations of stages or steps of the flowcharts or flow diagrams may be implemented by computer-executable program instructions. In some embodiments, one or more of the blocks, or stages or steps may not necessarily need to be performed in the order presented or may not necessarily need to be performed at all.

The computer-executable program instructions may be loaded onto a general-purpose computer, a special purpose computer, a processor, or other programmable data processing apparatus to produce a specific example of a machine. The instructions that are executed by the computer, processor, or other programmable data processing apparatus create means for implementing one or more of the functions, operations, processes, or methods disclosed and/or described herein. The computer program instructions may be stored in (or on) a computer-readable memory that may direct a computer or other programmable data processing apparatus to function in a specific manner, such that the instructions stored in (or on) the computer-readable memory produce an article of manufacture including instruction means that when executed implement one or more of the functions, operations, processes, or methods disclosed and/or described herein.

While embodiments of the disclosure have been described in connection with what is presently considered to be the most practical approach and technology, the embodiments are not limited to the disclosed implementations. Instead, the disclosed implementations are intended to include and cover modifications and equivalent arrangements included within the scope of the appended claims. Although specific terms are employed herein, they are used in a generic and descriptive sense only and not for purposes of limitation.

This written description uses examples to describe one or more embodiments of the disclosure, and to enable a person skilled in the art to practice the disclosed approach and technology, including making and using devices or systems and performing the associated methods. The patentable scope of the disclosure is defined by the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference was individually and specifically indicated to be incorporated by reference and/or was set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Method steps or stages disclosed and/or described herein may be performed in any suitable order unless otherwise indicated herein or clearly contradicted by context.

The use of examples or exemplary language (e.g., “such as”) herein, is intended to illustrate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer items in the alternative and in combination.

Different arrangements of the elements, structures, components, or steps illustrated in the figures or described herein, as well as components and steps not shown or described are possible. Similarly, some features and sub-combinations are useful and may be employed without reference to other features and sub-combinations. Embodiments have been described for illustrative and not for restrictive purposes, and alternative embodiments may become apparent to readers of the specification. Accordingly, the disclosure is not limited to the embodiments described in the specification or depicted in the figures, and modifications may be made without departing from the scope of the appended claims.

That which is claimed is:

1. A method for transferring risk associated with possible harm to an asset or disruption of a business arising from an environmental condition or event, comprising:
establishing a connection to a plurality of cryptocurrency wallets, wherein each wallet is associated with one of a plurality of user computing devices;
storing a plurality of account profiles, with one account profile associated with each computing device of the plurality of user computing devices, wherein each account profile includes a unique user identifier and a verified amount of cryptocurrency available from that user's respective cryptocurrency wallet;
receiving from at least one user computing device of the plurality of user computing devices, a hedge order to hedge against occurrence of a specific environmental condition or event, wherein the hedge order includes terms corresponding to a hedge premium offered, a risk coverage amount sought, a payout condition for the hedge order, a contract duration for the hedge order, and one or more data sources for use in determining whether the hedge order payout condition is satisfied;
receiving from at least one user computing device of the plurality of user computing devices, a risk order for a risk corresponding to occurrence of the specific environmental condition or event, wherein the risk order includes terms corresponding to a hedge premium sought, the risk coverage amount offered, a payout condition for the risk order, a contract duration for the risk order, and one or more data sources for use in determining whether the risk order payout condition is satisfied;
determining if the received hedge order and received risk order have acceptable values for the terms of the respective orders to proceed with establishing a smart contract between the received hedge order and received risk order;
generating a smart contract in a blockchain structure if the received hedge order and received risk order have acceptable values for the terms of the respective orders, wherein the smart contract includes at least one hedge user identifier, at least one risk user identifier, the hedge premium amount, the risk coverage amount, the payout condition or conditions, the contract duration, and the one or more of the data sources in the terms of the received hedge order and for the received risk order;
polling environmental data from one or more of the data sources in the smart contract;
determining based on the environmental data polled if the payout condition or conditions have been satisfied during the duration of the smart contract; and
disbursing the risk coverage amount to the hedge party if the payout condition or conditions have been met or disbursing the risk coverage amount to the risk party if the payout condition or conditions have not been met.

2. The method of claim 1, wherein the hedge order or risk order include one or more additional parameters or options, comprising:
a hedge premium payment to a party associated with the risk order if the payout condition or conditions are satisfied;
two or more payout conditions applicable to a single data source with a discrete hedge premium for each payout condition, wherein if one of the two or more payout conditions are satisfied, a payout is made to the user associated with the hedge order;
two or more data sources with a payout condition defined for each data source, whereas if one payout condition is satisfied, a payout is made to the user associated with the hedge order;
two or more data sources with a payout condition defined for each data source, whereas if all of the payout conditions are satisfied, a payout is made to the user associated with the hedge order;
a discount or price adjustment variable to override a default hedge premium cost calculation;
a contract service fee sharing percentage to be paid by the user associated with the hedge order and the user associated with the risk order; and
a desired number of blockchain Oracle checks over the duration of the smart contract to determine if a payout condition or conditions have been satisfied.

3. The method of claim 1, wherein the specific environmental condition or event is a risk category of space weather or a measurable event occurring in space.

4. The method of claim 3, wherein the data sources for the hedge order or for the risk order provide measurements of one or more of a Kp Index, a Dst Index, or a F10.7 Index.

5. The method of claim 1, wherein the specific environmental condition or event is a risk category of one or more of a hurricane, an earthquake, a flood level, a tropical storm, a level of precipitation or rainfall, a level of solar irradiance, a wildfire, a measured wind speed, a tornado measurement, a measure of air quality, a measured temperature, a wet bulb temperature, a tide water level, a measured wave height, an atmospheric gas measurement, a tsunami measurement, a volcanic eruption measurement, an algae bloom measurement, or a storm surge.

6. The method of claim 1, wherein the method is accessed through a platform or system, and further wherein a specific token is used as a currency for each unique risk category of environmental condition or event, the specific token being created by an administrator of the platform or system.

7. The method of claim 1, wherein the supply of risk coverage or risk capacity provided on the platform or system covering assets or businesses vulnerable to environmental conditions or events is decentralized across a community of discrete users associated with risk orders.

8. The method of claim 1, further comprising:
identifying at least one risk order that satisfies a portion of the risk coverage amount sought in a hedge order; and
splitting the hedge order into at least two smaller hedge orders, with at least one of the smaller hedge orders having a risk coverage amount that is equal to the risk coverage amount in the identified risk order.

9. The method of claim 1, further comprising enabling a conventional insurance carrier to access the platform marketplace for additional risk capacity.

10. The method of claim 1, wherein determining if the received hedge and risk orders have acceptable values for the terms of the respective orders to proceed with establishing a smart contract between the hedge order and risk order further comprises:
an exact match between the terms of the proposed hedge order and the proposed risk order; or
a match within a prescribed range of values for the terms of the hedge order and the risk order.

11. A system for transferring risk associated with possible harm to an asset or disruption of a business arising from an environmental condition or event, comprising:
one or more electronic processors configured to execute a set of computer-executable instructions; and
a non-transitory computer-readable medium including the set of computer-executable instructions, wherein when executed, the instructions cause the one or more electronic processors to
establish a connection to a plurality of cryptocurrency wallets, wherein each wallet is associated with one of a plurality of user computing devices;
store a plurality of account profiles, with one account profile associated with each computing device of the plurality of user computing devices, wherein each account profile includes a unique user identifier and a verified amount of cryptocurrency available from that user's respective cryptocurrency wallet;
receive from at least one user computing device of the plurality of user computing devices, a hedge order to hedge against occurrence of a specific environmental condition or event, wherein the hedge order includes terms corresponding to a hedge premium offered, a risk coverage amount sought, a payout condition for the hedge order, a contract duration for the hedge order, and one or more data sources for use in determining whether the hedge order payout condition is satisfied;
receive from at least one user computing device of the plurality of user computing devices, a risk order for a risk corresponding to occurrence of the specific environmental condition or event, wherein the risk order includes terms corresponding to a hedge premium sought, the risk coverage amount offered, a payout condition for the risk order, a contract duration for the risk order, and one or more data sources for use in determining whether the risk order payout condition is satisfied;
determine if the received hedge order and received risk order have acceptable values for the terms of the respective orders to proceed with establishing a smart contract between the received hedge order and received risk order;
generate a smart contract in a blockchain structure if the received hedge order and received risk order have acceptable values for the terms of the respective orders, wherein the smart contract includes at least one hedge user identifier, at least one risk user identifier, the hedge premium amount, the risk coverage amount, the payout condition or conditions, the contract duration, and the one or more of the data sources in the terms of the received hedge order and for the received risk order;
poll environmental data from one or more of the data sources in the smart contract;
determine based on the environmental data polled if the payout condition or conditions have been satisfied during the duration of the smart contract; and
disburse the risk coverage amount to the hedge party if the payout condition or conditions have been met or disbursing the risk coverage amount to the risk party if the payout condition or conditions have not been met.

12. The system of claim 11, wherein the hedge order or risk order include one or more additional parameters or options, comprising:
a hedge premium payment to a party associated with the risk order if the payout condition or conditions are satisfied;
two or more payout conditions applicable to a single data source with a discrete hedge premium for each payout condition, wherein if one of the two or more payout conditions are satisfied, a payout is made to the user associated with the hedge order;
two or more data sources with a payout condition defined for each data source, whereas if one payout condition is satisfied, a payout is made to the user associated with the hedge order;
two or more data sources with a payout condition defined for each data source, whereas if all of the payout conditions are satisfied, a payout is made to the user associated with the hedge order;
a discount or price adjustment variable to override a default hedge premium cost calculation;
a contract service fee sharing percentage to be paid by the user associated with the hedge order and the user associated with the risk order; and
a desired number of blockchain Oracle checks over the duration of the smart contract to determine if a payout condition or conditions have been satisfied.

13. The system of claim 11, wherein the specific environmental condition or event is a risk category of space weather or a measurable event occurring in space.

14. The system of claim 11, wherein the specific environmental condition or event is a risk category of one or more of a hurricane, an earthquake, a flood level, a tropical storm, a level of precipitation or rainfall, a level of solar irradiance, a wildfire, a measured wind speed, a tornado measurement, a measure of air quality, a measured temperature, a wet bulb temperature, a tide water level, a measured wave height, an atmospheric gas measurement, a tsunami measurement, a volcanic eruption measurement, an algae bloom measurement, or a storm surge.

15. The system of claim 11, wherein a specific token is used as a currency for each unique risk category of environmental condition or event, the specific token being created by an administrator of the platform or system used to enable the transfer of risk.

16. The system of claim 11, wherein the instructions further cause the one or more electronic processors to:
identify at least one risk order that satisfies a portion of the risk coverage amount sought in a hedge order; and
split the hedge order into at least two smaller hedge orders, with at least one of the smaller hedge orders having a risk coverage amount that is equal to the risk coverage amount in the identified risk order.

17. A non-transitory computer readable medium containing a set of computer-executable instructions that when executed by one or more programmed electronic processors, cause the processors to perform a process for risk transfer for possible harm to an asset or disruption of a business arising from an environmental condition or event by:
establishing a connection to a plurality of cryptocurrency wallets, wherein each wallet is associated with one of a plurality of user computing devices;
storing a plurality of account profiles, with one account profile associated with each computing device of the plurality of user computing devices, wherein each account profile includes a unique user identifier and a verified amount of cryptocurrency available from that user's respective cryptocurrency wallet;
receiving from at least one user computing device of the plurality of user computing devices, a hedge order to hedge against occurrence of a specific environmental condition of event, wherein the hedge order includes terms corresponding to a hedge premium offered, a risk coverage amount sought, a payout condition for the hedge order, a contract duration for the hedge order, and one or more data sources for use in determining whether the hedge order payout condition is satisfied;
receiving from at least one user computing device of the plurality of user computing devices, a risk order for a risk corresponding to occurrence of the specific environmental condition or event, wherein the risk order includes terms corresponding to a hedge premium sought, the risk coverage amount offered, a payout condition for the risk order, a contract duration for the risk order, and one or more data sources for use in determining whether the risk order payout condition is satisfied;
determining if the received hedge order and received risk order have acceptable values for the terms of the respective orders to proceed with establishing a smart contract between the received hedge order and received risk order;
generating a smart contract in a blockchain structure if the received hedge order and received risk order have acceptable values for the terms of the respective orders, wherein the smart contract includes at least one hedge user identifier, at least one risk user identifier, the hedge premium amount, the risk coverage amount, the payout condition or conditions, the contract duration, and the one or more of the data sources in the terms of the received hedge order and for the received risk order;
polling environmental data from one or more of the data sources in the smart contract;
determining based on the environmental data polled if the payout condition or conditions have been satisfied during the duration of the smart contract; and
disbursing the risk coverage amount to the hedge party if the payout condition or conditions have been met or disbursing the risk coverage amount to the risk party if the payout condition or conditions have not been met.

18. The one or more non-transitory computer readable medium of claim 17, wherein the hedge order or risk order include one or more additional parameters or options, comprising:
a hedge premium payment to a party associated with the risk order if the payout condition or conditions are satisfied;
two or more payout conditions applicable to a single data source with a discrete hedge premium for each payout condition, wherein if one of the two or more payout conditions are satisfied, a payout is made to the user associated with the hedge order;
two or more data sources with a payout condition defined for each data source, whereas if one payout condition is satisfied, a payout is made to the user associated with the hedge order;
two or more data sources with a payout condition defined for each data source, whereas if all of the payout conditions are satisfied, a payout is made to the user associated with the hedge order;
a discount or price adjustment variable to override a default hedge premium cost calculation;
a contract service fee sharing percentage to be paid by the user associated with the hedge order and the user associated with the risk order; and
a desired number of blockchain Oracle checks over the duration of the smart contract to determine if a payout condition or conditions have been satisfied.

19. The one or more non-transitory computer readable medium of claim 17, wherein the specific environmental condition or event is a risk category of space weather or a measurable event occurring in space.

20. The one or more non-transitory computer readable medium of claim 17, wherein the specific environmental condition or event is a risk category of one or more of a hurricane, an earthquake, a flood level, a tropical storm, a level of precipitation or rainfall, a level of solar Irradiance, a wildfire, a measured wind speed, a tornado measurement, a measure of air quality, a measured temperature, a wet bulb temperature, a tide water level, a measured wave height, an atmospheric gas measurement, a tsunami measurement, a volcanic eruption measurement, an algae bloom measurement, or a storm surge.
